(19) United States
(12) Patent Application Publication
(10) Pub. No.: US 2021/0402780 A1
(43) Pub. Date: Dec. 30, 2021

(54) LIQUID SUPPLY APPARATUS AND LIQUID SUPPLY SYSTEM

(71) Applicant: Konica Minolta, Inc., Tokyo (JP)

(72) Inventor: Mitsuo KABURAGI, Tokyo (JP)

(21) Appl. No.: 17/358,824

(22) Filed: Jun. 25, 2021

(30) Foreign Application Priority Data
Jun. 29, 2020 (JP) 2020-111044

(51) Int. Cl. B41J 2/175

(52) U.S. Cl. CPC B41J 2/17506

(57) ABSTRACT

Discloses is a liquid supply apparatus that supplies liquid to a liquid ejection apparatus, including: a liquid tank that stores the liquid; and a conveyer that loads a refill container to a refill position of the liquid tank to replenish the liquid.

### CROSS-REFERENCE TO RELATED APPLICATIONS

The present invention claims priority under 35 U.S.C. § 119 to Japanese Patent Application No. 2020-111044, filed on Jun. 29, 2020, the entire content of which is incorporated herein by reference.

### BACKGROUND

### Technological Field

The present invention relates to a liquid supply apparatus and a liquid supply system that supply a liquid to a liquid ejection apparatus.

### Description of the Related Art

A liquid ejection apparatus such as a conventional inkjet recording apparatus is supplied with ink from an ink supply apparatus that has a large ink tank and is disposed outside the main body, so as to be able to eject a large amount of ink (See, for example, JP-A-2019-214160).

### SUMMARY

However, since the apparatus of Patent Document 1 includes a large ink tank, there has been a problem of a large work burden of refilling the ink tank with ink.

It is an object of the present invention to reduce the work burden of refilling and to properly replenish the liquid.

In order to achieve the above object, the liquid supply apparatus of the present invention is configured to supply liquid to a liquid ejection apparatus and includes a liquid tank for storing the liquid and a conveyer that loads a refill container to a refill position of the liquid tank to replenish the liquid.

Further, the liquid supply system of the present invention includes the liquid supply apparatuses individually for each different type of the liquid.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 is a perspective view of the ink supply apparatus according to a first embodiment in a state in which refill containers are stored;

FIG. 2 is a perspective view of the ink supply apparatus in a state in which a conveyer stands by at a receiving position for a refill container;

FIG. 3 is a perspective view of the ink supply apparatus in a state in which a lift mechanism passes a refill container to the conveyer;

FIG. 4 is a perspective view of the ink supply apparatus in a state in which the conveyer discards a refill container;

FIG. 5A is a front view of the ink supply apparatus, FIG. 5B is a plan view thereof, and FIG. 5C is a left side view thereof;

FIG. 6 is a front view of a refill container;

FIG. 7 is a front view of another example of a refill container with a handle in a different position;

FIG. 8A is a plan view of a lid of the refill container, FIG. 8B is a cross-sectional view of the lid along the line W-W in FIG. 8A, and FIG. 8C is an enlarged cross-sectional view of the area F in FIG. 8B;

FIG. 9 is a perspective view of a storage as viewed diagonally from the front left;

FIG. 10 is a perspective view of the storage as viewed diagonally from the front right;

FIG. 11 is a side view of a regulation frame as viewed from the right;

FIG. 12 is a perspective view illustrating a receiving action of a refill container at the conveyer;

FIG. 13 is a perspective view illustrating a rotating action of the conveyer after receiving the refill container;

FIG. 14 is a perspective view illustrating a stirring action of the conveyer for stirring a refill container;

FIG. 15 is a perspective view illustrating a loading action of the conveyer for loading a refill container to an ink tank;

FIG. 16 is a perspective view illustrating an unloading action of the conveyer for unloading the refill container from the ink tank;

FIG. 17 is a perspective view illustrating a discarding action of the conveyer for discarding the refill container;

FIG. 18 is a cross-sectional view illustrating the state of ink in a refill container in a position that the longitudinal direction of the refill container is in the horizontal direction;

FIG. 19 is a cross-sectional view illustrating a state of ink in the refill container in a position that the longitudinal direction of the refill container is in the vertical direction;

FIG. 20 is a diagram illustrating the relationship between the amplitude and the impact force generated in the refill container when the refill container is in a position that the longitudinal direction is in the horizontal direction and a stirring action is performed in the longitudinal direction;

FIG. 21 is a cross-sectional view illustrating the configuration of the upper part of the ink tank;

FIG. 22 is a cross-sectional view illustrating the overall configuration of the ink tank;

FIG. 23 is a block diagram illustrating a control configuration of the ink supply apparatus;

FIG. 24 is a plan view of an inkjet recording system including an ink supply system and an inkjet recording apparatus, illustrating the configuration and layout thereof;

FIG. 25 is a perspective view of an ink supply apparatus according to a second embodiment;

FIG. 26A is a front view of the ink supply apparatus according to the second embodiment, FIG. 26B is a plan view thereof, and FIG. 26C is a left side view thereof;

FIG. 27 is a perspective view of the ink supply apparatus according to a third embodiment;

FIG. 28A is a front view of the ink supply apparatus according to the third embodiment, FIG. 28B is a plan view thereof, and FIG. 28C is a left side view thereof;

FIG. 29 is a plan view of an inkjet recording system including an ink supply system and an inkjet recording apparatus, illustrating the configuration and layout thereof;

FIG. 30 is a perspective view of an ink supply apparatus according to a fourth embodiment;

FIG. 31A is a front view of an ink supply apparatus according to the fourth embodiment, and FIG. 31B is a plan view thereof;

FIG. 32 A is a cross-sectional view of the ink supply apparatus along the line V-V in FIG. 31A, and FIG. 32B is a left side view of the ink supply apparatus;

FIG. 33 is a plan view of an inkjet recording system including an ink supply system and an inkjet recording apparatus, illustrating the configuration and layout thereof;

FIG. 34 is a perspective view of an ink supply apparatus according to a fifth embodiment;

FIG. 35A is a front view of the ink supply apparatus according to the fifth embodiment, FIG. 35B is a plan view thereof, and FIG. 35 C is a left side view thereof; and

FIG. 36 is a plan view of an inkjet recording system including an ink supply system and an inkjet recording apparatus, illustrating the configuration and layout thereof.

### DETAILED DESCRIPTION OF THE EMBODIMENTS

Hereinafter, embodiments of the liquid supply apparatus and the liquid supply system of the present invention will be described referring to the drawings. However, the scope of the invention is not limited to the disclosed embodiments.

### First Embodiment

Hereinafter, a first embodiments of the present invention will be described based on the drawings.

In the embodiment of the present invention, an ink supply apparatus 1 is illustrated as an example of the liquid supply apparatus. The ink supply apparatus 1 supplies ink to an inkjet recording apparatus, which is a liquid ejection apparatus that ejects ink (liquid).

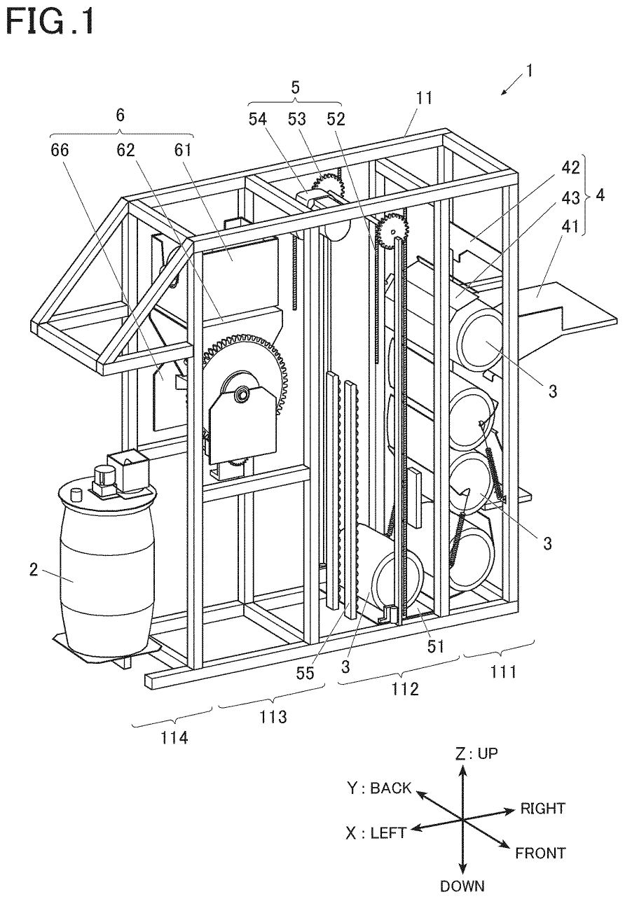

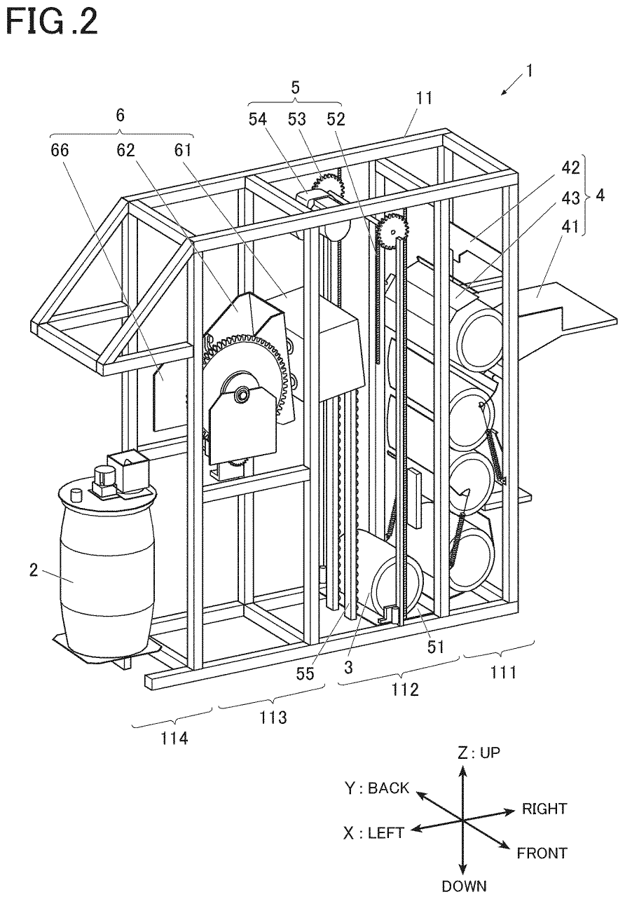

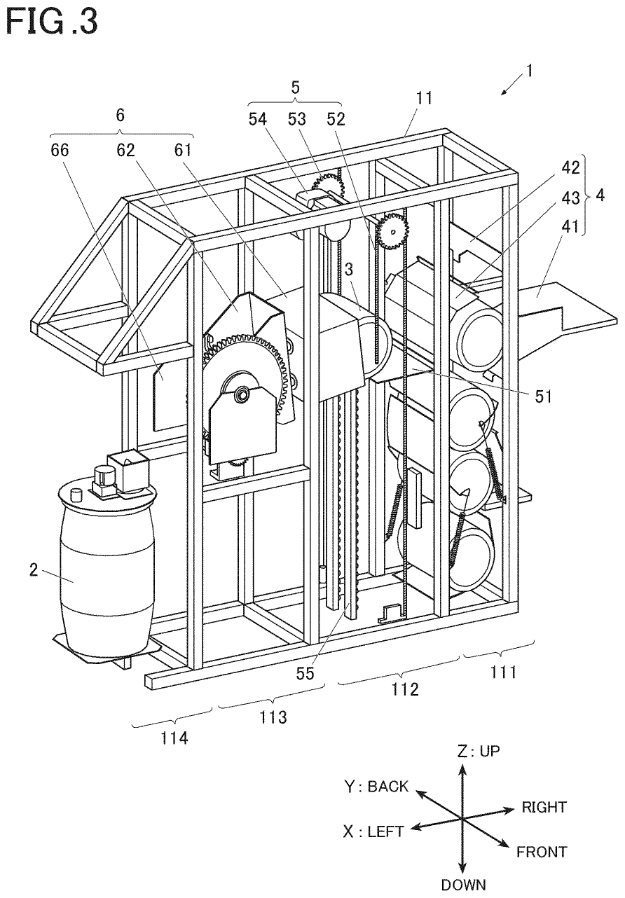

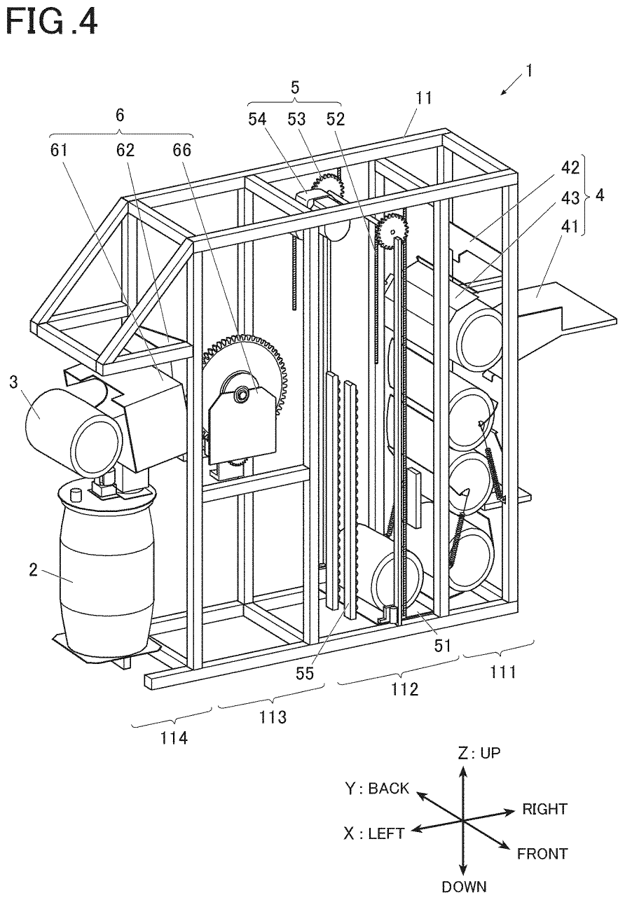

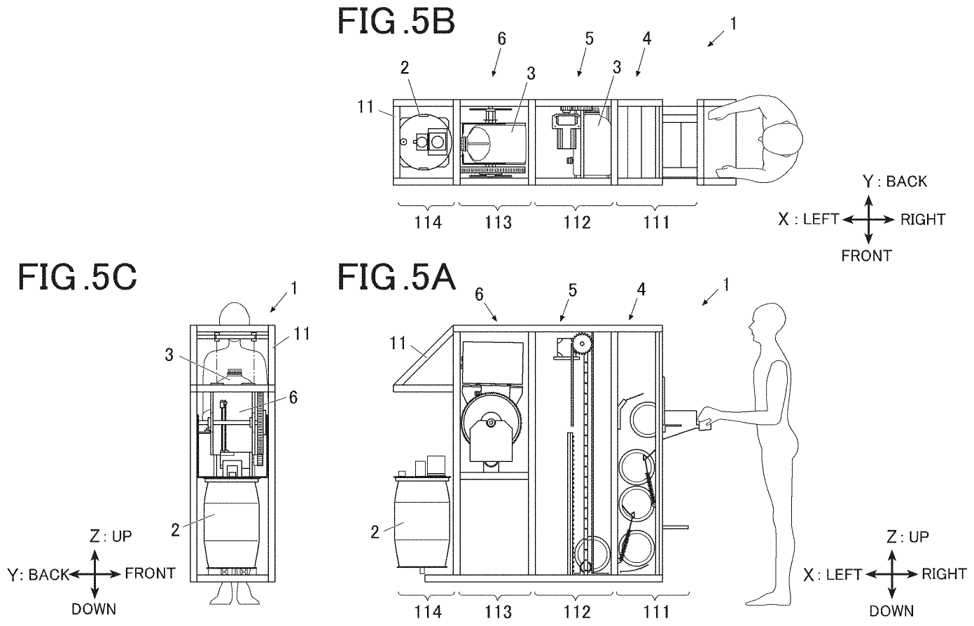

FIG. 1 to FIG. 4 are perspective views of the ink supply apparatus 1, FIG. 5A is a front view thereof, FIG. 5B is a left side view thereof, and FIG. 5C is a plan view thereof.

### [Outline Configuration of Ink Supply Apparatus]

The ink supply apparatus 1 includes: a large-capacity ink tank 2 that supplies ink to an inkjet recording apparatus via a pump and a pipeline including a hose, a pipe and the like (not shown in the figures); a refill container 3 for refilling the ink tank 2 with ink; a storage 4 that stores a plurality of refill containers 3; a lift mechanism 5 that transfers the foremost refill container 3 in the storage 4 to the next step; a conveyer 6 that receives and holds the refill container 3 from the lift mechanism 5 at a predetermined receiving position and conveys and loads the refill container 3 to a refill position of the ink tank 2; a frame 11 that supports these components; and a controller 9 (hardware processor) that controls the ink supply apparatus 1.

In the ink supply apparatus 1, the height direction of the frame 11 is referred to as the vertical direction or the Z-axis direction, the longitudinal direction of the frame 11 in a plan view is referred to as the X-axis direction, and the transverse direction is referred to as the Y-axis direction.

Further, in the ink supply apparatus 1, one side along the Y axis is defined as “front”, and the other is defined as “rear”. Further, from a viewpoint facing the front side of the ink supply apparatus 1, the left-hand side of the X-axis is defined as “left”, and the right-hand side is defined as “right”.

### [Refill Container]

The ink supply apparatus 1 includes the ink tank 2, which is a large-capacity (for example, 90 L) liquid tank for storing ink. The ink supply apparatus 1 replenishes ink to the ink tank 2 from the refill container 3, which has a smaller capacity than the ink tank 2 (for example, 10 L).

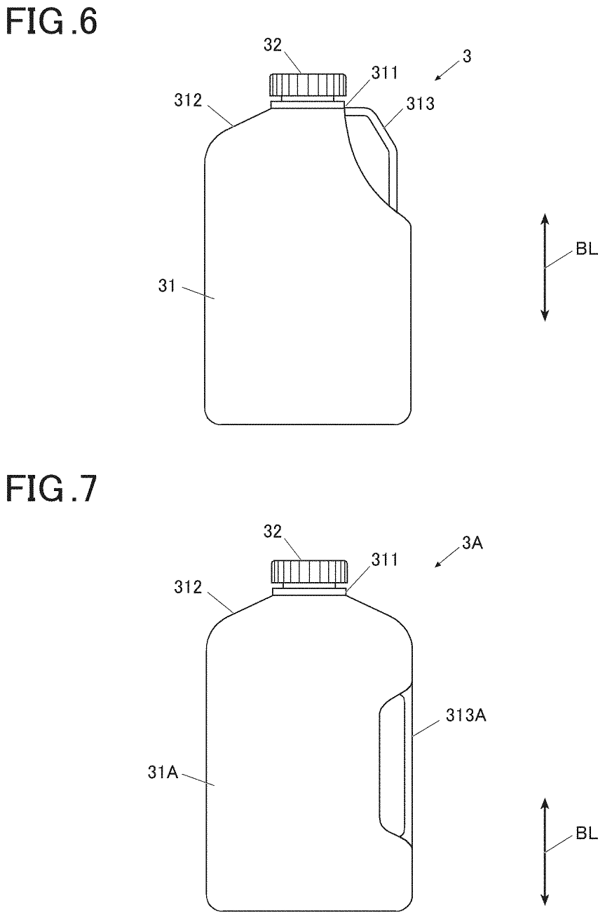

FIG. 6 is a front view of the refill container 3.

The refill container 3 is a bottle container made of a resin such as polyethylene or polypropylene. The refill container 3 includes a container body 31 for storing ink and a lid 32 attached to a bottle opening 311. The bottle opening 311 is formed at one end (upper end in FIG. 6) of the container body 31 in the longitudinal direction BL.

The container body 31 has a substantially cylindrical shape with the center axis in the longitudinal direction BL. In the vicinity of the bottle opening 311, a tapered portion 312 is formed. The cross-sectional area vertical to the axis of the tapered portion 312 decreases toward the bottle opening side. When the container body 31 is tilted so that the bottle opening 311 faces downward, the tapered surface inside the tapered portion 312 guides the ink to the bottle opening 311 so that the ink can be discharged well.

Further, the container body 31 has a handle 313 at one end closer to the bottle opening 311 in the longitudinal direction BL and at a recessed part in the circumferential direction of the tapered portion 312. Since the handle 313 is formed in the recessed part, the handle 313 does not protrude from the outer diameter of the overall outer circumference of the container body 31. Accordingly, the handle 313 does not prevent the refill container 3 from rolling about an axis in the longitudinal direction BL.

The arrangement of the handle 313 of the container body 31 of the refill container 3 is not limited to one end in the longitudinal direction BL. For example, as shown in FIG. 7, a handle 313A may be provided in a middle part in the longitudinal direction BL. Also in this case, it is preferable to dispose the handle 313 so as not to protrude from the outer diameter of the overall outer circumference of the container body 31.

Although the details will be described later, when the refill container 3 is loaded into the storage 4 of the ink supply apparatus 1, the refill container 3 is loaded in a lying position in which the longitudinal direction BL is horizontal. The refill container 3 is heavy enough to cause a certain burden on a person to handle. When the refill container 3 is loaded in the horizontal position, the refill container 3 can be held in a well-balanced manner if the handle is provided in the middle rather than at one end in the longitudinal direction BL. This improves the workability.

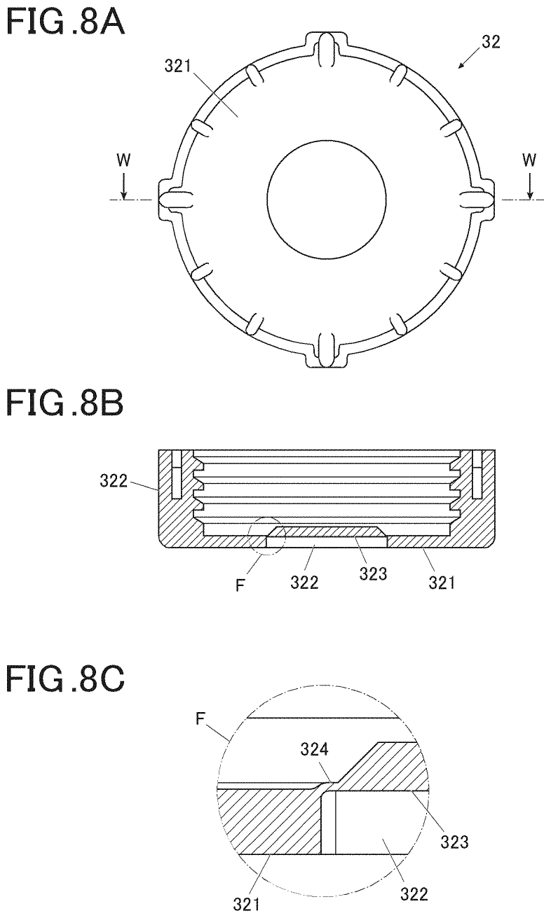

FIG. 8A is a plan view of the lid 32 of the refill container 3, FIG. 8B is an axial sectional view of the lid 32, and FIG. 8C is an enlarged sectional view of an area F in FIG. 8B.

The lid 32 is a cylindrical body with one end closed. On the inner peripheral surface of the lid 32, a female screw is formed. The female screw is screwed to a male screw formed at the bottle opening 311 of the container body 31. That is, the lid 32 is a so-called screw cap that is screwed to the bottle opening 311 of the container body 31 to hermetically seal the refill container 3.

A circular recess 323 is formed in the center of the closing surface 321 on the one end of the lid 32. As shown in FIG. 8C, a fragile portion 324 that is thinner than the other portion of the closing surface 321 is formed along the inner edge of the circular recess 323. When the recess 323 of the closing surface 321 of the lid 32 is pressed from the outside with a certain force, the fragile portion 324 is torn to be a circular opening 322 as an outlet, and the ink in the refill container 3 becomes dischargeable through the opening 322.

The lid 32 is also integrally formed from a resin such as polyethylene or polypropylene. When the lid 32 is torn all around along the fragile portion 324 of the recess 323, a circular cut piece is pushed into the refill container 3. When the lid 32 is made of the resin as described above, burrs are formed on the inner edge of the opening 322 as a result of the tearing. When the ink is poured out, the circular cut piece is caught in the burrs and is not discharged through the opening 322. This can prevent the circular cut piece from falling into the ink tank 2.

The ink supply apparatus 1 supplies, for example, ultraviolet (UV) curable ink. The UV curable ink changes its phase between a gel state and a liquid (sol) state depending on the temperature until the ink is irradiated with UV. The ink in a high-viscosity gel state at room temperature, and changes to a low-viscosity liquid at a high temperature (for example, 60° C. or higher).

Even in a gel state, the ink tends to be gradually separated into an ink component and other components such as additives.

As described above, when the ink is replenished from the refill container 3 to the ink tank 2, the viscosity of the ink may sometimes be high at ambient temperature. Even in such cases, the above structure of the refill container 3 allows the ink to be smoothly drained into the ink tank 2.

The above-described ink to be supplied is merely an example, and the ink supply apparatus 1 may supply any ink.

### [Frame]

As shown in FIG. 1, the frame 11 is a support skeleton structure composed of a plurality of connected beams, and has a substantially rectangular parallelepiped shape that is narrower in the Y-axis direction than in the X-axis direction and the Z-axis direction.

From right to left, the frame 11 includes an installation area 111 that supports the storage 4, an installation area 112 that supports the lift mechanism 5, an installation area 113 that supports the conveyer 6, and an installation area 114 that supports the ink tank 2.

### [Storage]

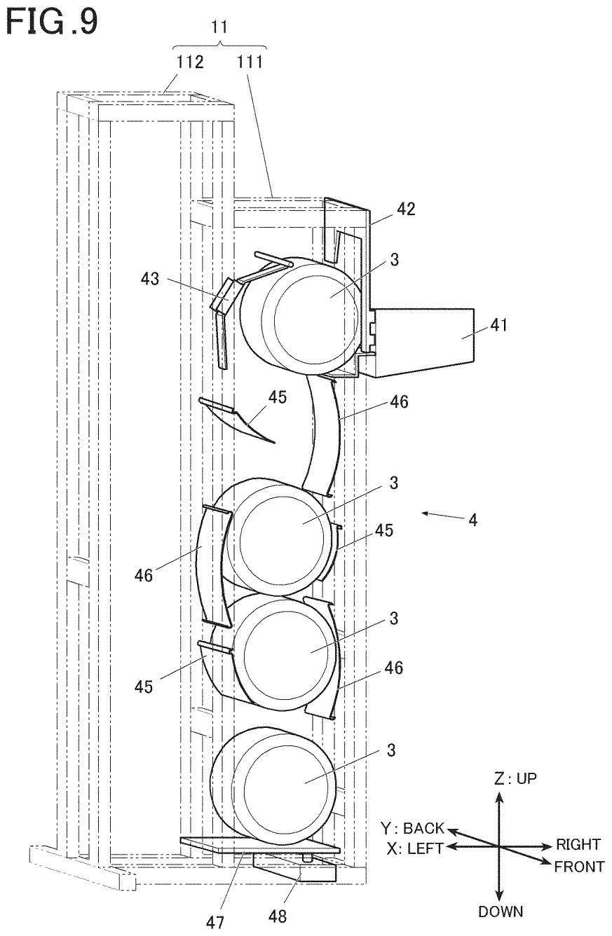

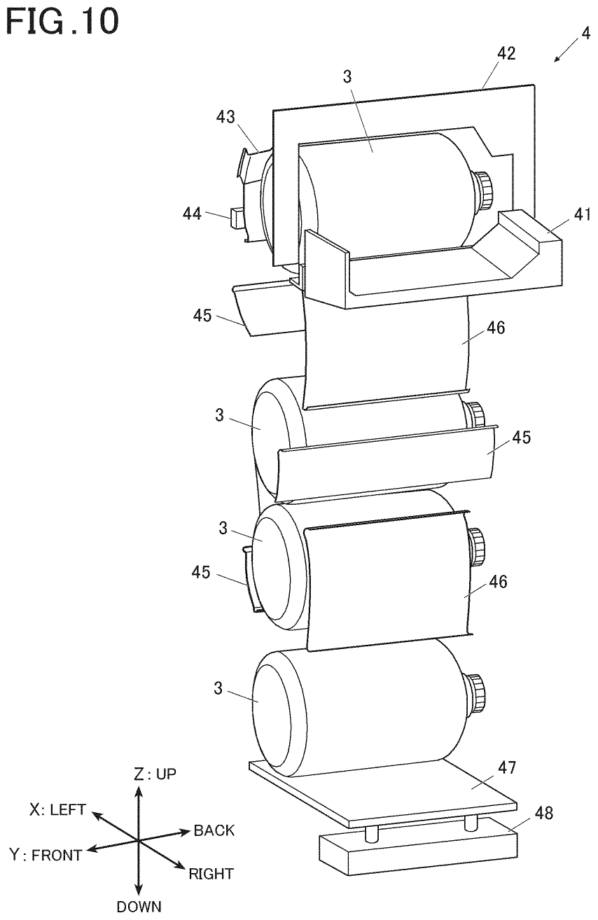

FIG. 9 is a perspective view of the storage 4 as viewed diagonally from the front left, and FIG. 10 is a perspective view of the same as viewed diagonally from the front right.

The storage 4 includes: a guide slope 41 that is disposed at an upper part of the right side of the frame 11 to guide the refill container 3 to an inlet for loading the refill container 3 to the storage 4; a regulation frame 42 that allows the refill container 3 to pass the inlet in a position in which the longitudinal direction BL is in a lateral (horizontal) direction; a first guide 43 that guides the loaded refill container 3 to move downward; an inlet sensor 44 that detects passage of the refill container 3 through the first guide 43; a damper 45 that makes the refill container 3 move in a moderate speed; a second guide 46 that guides the refill container 3 to move downward from the first guide 43 in cooperation with the damper 45; a weight sensor 47 that detects the total weight of the refill container(s) 3 stored in the storage 4; and a transfer actuator 48 that transfers the lowermost refill container 3 from the storage 4 to the lift mechanism 5.

The guide slope 41 includes a slope that guides the refill container 3 into the inlet. The slope has a gradient that descends from right to left. When the refill container 3 is placed on the guide slope 41 in a sideways position, the refill container 3 rolls toward the regulation frame 42 provided on the left side.

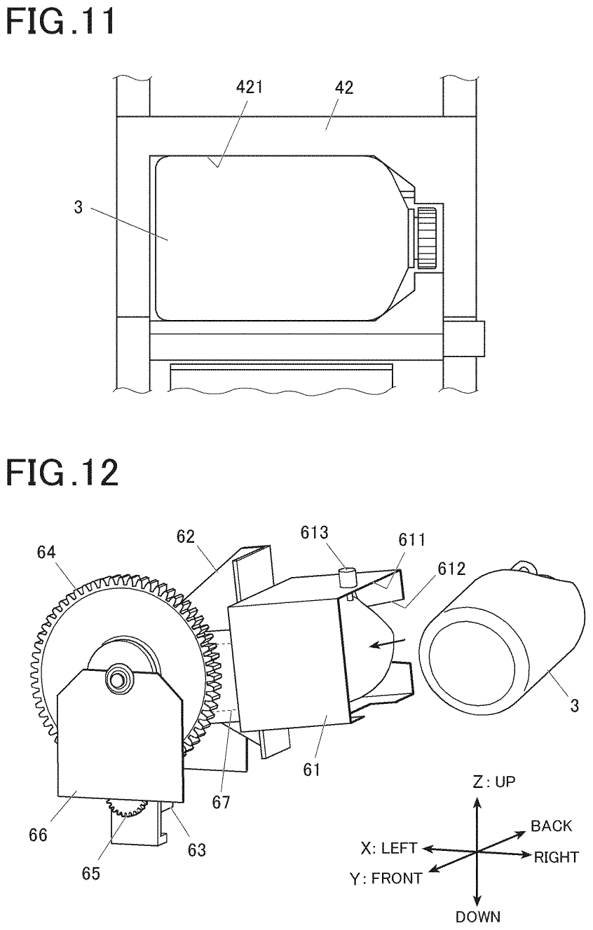

FIG. 11 is a side view of the regulation frame 42 as viewed from the right.

The regulation frame 42 is a rectangular flat plate frame with an opening through which the refill container 3 passes. The regulation frame 42 is attached to the upper part of the right side wall of the frame 11 in parallel to the Y-Z plane.

The opening of the regulation frame 42 has substantially the same shape as the cross section including the center line of the refill container 3 in a tilted position in which the longitudinal direction is horizontal (hereinafter referred to as sideways position). Further, the opening of the regulation frame 42 is formed in the shape corresponding to a cross section of the refill container 3 in a position in which the lid 32 faces backward.

Therefore, in order to load the refill container 3 into the storage 4, it is necessary to let the refill container 3 pass in a position that fits to the opening of the regulation frame 42. Therefore, all the refill containers 3 stored in the storage 4 are stored in the sideways position with the lids 32 facing backward.

The first guide 43 comes in sliding contact with the outer peripheral surface of the refill container 3 that has passed through the regulation frame 42, so as to change the course of the refill container 3 from left to down.

The first guide 43 can be slightly swung when it comes in sliding contact with the outer peripheral surface of the refill container 3. The inlet sensor 44 attached to the first guide 43 detects loading of the refill container 3 by detecting swing of the first guide 43. Detection signals of the inlet sensor 44 are input to the controller 9. The controller 9 acquires the number of refill containers 3 loaded into the storage 4 by counting the detection signals.

The first guide 43 may be bendable when it comes in sliding contact with the outer peripheral surface of the refill container 3. In this case, the inlet sensor 44 may be constituted by a strain gauge or the like that detects deflection of the first guide 43.

The damper 45 and the second guide 46 are paired with each other, and are arranged so that the refill container 3 moving downward passes through between them.

The damper 45 is a slightly curved plate, one end of which is rotatably supported by the frame 11 around the Y axis, and the other end of which extends toward the second guide 46.

The second guide 46 has a plate shape that is substantially parallel to the Y-Z plane. The second guide 46 is slightly curved so as to be concave toward the damper 45.

The damper 45 is connected to a damper and a shock absorber. When the loaded refill container 3 lands on the other end extending toward the second guide 46, the damper 45 is slowly turned by the weight of the refill container 3. This prevents the refill container 3 from fiercely falling down. The refill container 3 passes through between the damper 45 with the other rotated downward and the second guide 46, and moves further downward. After the refill container 3 passes through, the other end of the damper 45 returns to the original position to face the second guide 46.

The storage 4 has a vertically elongated structure, and stores a plurality of refill containers 3 that are in the sideways position and are arranged in the vertical direction.

Accordingly, a plural pairs of the damper 45 and the second guide 46 are arranged in the vertical direction. The pairs of the damper 45 and the second guide 46 are arranged vertically in the storage 4 such that the position of the damper 45 and the second guide 46 are alternated in the vertical direction.

The refill containers 3 are loaded sideways, and the second guides 46 are curved in a concave shape toward the damper 45. This allows the refill containers 3 to move downward while maintaining the sideways position.

In the storage 4, all of the plurality of refill containers 3 can be stored in the sideways position.

The weight sensor 47 is disposed at the bottom of the storage 4, and can detect the weight of the refill container(s) 3 placed on the upper surface. As described above, since a plurality of refill containers 3 is vertically stacked in the storage 4, the weight sensor 47 located at the lowest part can detect the total weight of all stacked refill containers 3.

The transfer actuator 48 can push up the right end of the flat plate weight sensor 47 to tilt the plate downward to the left. As the transfer actuator 48, for example, a linear actuator such as a solenoid is used.

In the case where there is a refill container 3 on the weight sensor 47 and no other refill containers 3 is stacked on the refill container 3, when the weight sensor 47 is tilted downward to the left, the refill container 3 rolls to the left and moves to the lift mechanism 5 side. In the case where there is a refill container 3 on the weight sensor 47 and another refill container 3 is further stacked on the refill container 3, when the weight sensor 47 is tilted downward to the left, the upper refill container 3 is displaced to the right with respect to the lower refill container 3. Then, the lower refill container 3 is pushed to the left and moves toward the lift mechanism 5 by the weight of the upper refill container 3.

As described above, the controller 9 counts the number of refill containers 3 loaded to the storage 4 based on the detection signals of the inlet sensor 44. Further based on the number of times the transfer actuator 48 is driven, the controller 9 can determine the number of refill containers 3 sent out from the storage 4.

Accordingly, the controller 9 can obtain the number of the refill containers 3 in the storage 4 by counting up with the detection signals of the inlet sensor 44 and counting down with the drives of the transfer actuator 48.

Further, the detection signals of the weight sensor 47 are input to the controller 9. The controller 9 monitors whether a value obtained by multiplying the number of the refill containers 3 by the weight of each refill container 3 matches the total weight of the refill containers 3 in the storage 4. If the difference between the values is equal to or greater than a specified value, the controller 9 determines that the values do not match, and some abnormality such as liquid leakage from a refill container 3 has occurred. The controller 9 executes a notification processing such as displaying a notification screen indicating the occurrence of an abnormality on a display 95 or the like connected to the controller 9.

### [Lift Mechanism]

As shown in FIG. 1 to FIG. 5, the lift mechanism 5 includes: a lift plate 51 on which the refill container 3 is to be placed; a chain 52 connected to the lift plate 51; a chain sprocket 53 which winds the chain 52 for conveyance; and a lift motor 54 that rotationally drives the chain sprocket 53; and a regulation bar 55 that abuts the refill container 3 placed on the lift plate 51 to prevent the refill container 3 from moving to the left.

The lift plate 51 stands by at the destination of the refill container 3 transferred by the transfer actuator 48 of the storage 4, and can receive the transferred refill container 3.

The upper surface of the lift plate 51 is slightly inclined downward to the left, which prevents the refill container 3 placed on the lift plate 51 from rolling to the right.

On the left side of the lift plate 51, a regulation bar 55 is provided. The refill container 3 on the lift plate 51 is moved upward while the refill container 3 is in contact with the regulation bar 55 due to the left downward inclination.

The left side of the upper end of the regulation bar 55 is a receiving position of the conveyer 6 for the refill container 3. That is, when the lift plate 51 is elevated beyond the upper end of the regulation bar 55, the refill container 3 on the lift plate 51 rolls to the left to the receiving position of the conveyer 6 because there is nothing to restrict the movement to the left.

### [Conveyer]

FIG. 12 to FIG. 17 are perspective views sequentially illustrating the actions of the conveyer 6.

The conveyer 6 includes: a holding frame 61 for the refill container 3, which has a box shape with one side open; an arm 62 that supports the holding frame 61; a bottle conveying motor 63 that is a drive source for the rotational action of the arm 62; a driving gear 65 attached to the output shaft of the bottle conveying motor 63; a driven gear 64 attached to the arm 62; and a support bracket 66 fixed to the frame 11 and rotatably supporting the arm 62.

The holding frame 61 is a hollow rectangular parallelepiped housing, and is supported by the arm 62 at one surface parallel to the longitudinal direction of the six surfaces, and the surface opposed to the surface supported by the arm 62 is open. This open side serves as an inlet/outlet 611 of the holding frame 61 for the refill container 3.

A notch 612 is formed in the surface of the holding frame 61 at one side in the longitudinal direction adjacent to the inlet/outlet 611. The notch 612 is formed from the inlet/outlet 611 toward the arm 62. The notch 612 is provided to hold the lid 32 in a state of being exposed to the outside of the holding frame 61 when the refill container 3 is placed in the holding frame 61.

A bottle holding actuator 613 is provided in the vicinity of the inlet/outlet 611 of the holding frame 61. The bottle holding actuator 613 is provided in the vicinity of the inlet/outlet 611 on a surface parallel to the longitudinal direction of the holding frame 61 that is not the surface supported by the arm 62. The bottle holding actuator 613 includes a pin that projects inward of the holding frame 61. When the pin is protruded, the bottle holding actuator 613 restricts the refill container 3 in the holding frame 61 from moving out through the inlet/outlet 611. When the pin is retracted, the bottle holding actuator 613 allows the refill container 3 to be discharged through the inlet/outlet 611.

As the bottle holding actuator 613, for example, a linear actuator such as a solenoid can be used.

The arm 62 is supported by a support bracket 66 in a swingable manner around the Y axis. The arm 62 supports the holding frame 61 at the swinging end, and the inlet/outlet 611 of the holding frame 61 is open outward in the direction of the swing radius of the arm 62.

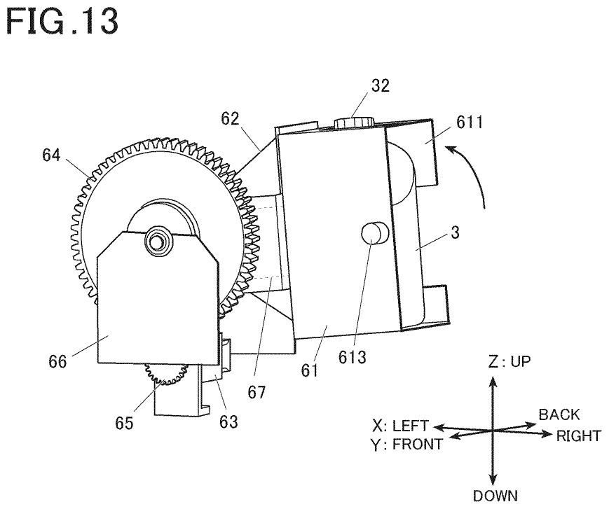

Further, the arm 62 supports the holding frame 61 in a rotatable manner around an axis extending in the direction of the swing radius. A bottle rotating motor 67 is provided to the arm 62 to rotate the holding frame 61 about an axis in the direction of the swing radius of the arm 62 so as to be able to turn the longitudinal direction of the holding frame 61 (the longitudinal direction of the refill container 3) to any direction (see the arrow in FIG. 13).

The bottle rotating motor 67 is controlled by the controller 9.

As described above, the support bracket 66 is fixed to the frame 11 and supports the bottle conveying motor 63, the driving gear 65, the arm 62, and the like.

A driven gear 64 is fixed on the arm 62 coaxially with the swing center of the arm 62, and the arm 62 is swung integrally with the rotation of the driven gear 64.

The support bracket 66 supports the driving gear 65 in the vicinity of the arm 62 so that the driving gear 54 meshes with the driven gear 64. Since the driving gear 65 has a smaller number of teeth than the driven gear 64, the rotation of the bottle conveying motor 63 is reduced and transmitted to the arm 62.

The bottle conveying motor 63 is controlled by the controller 9 and can swing and carry the holding frame 61 and the refill container 3 to any position via the driving gear 65 and the driven gear 64.

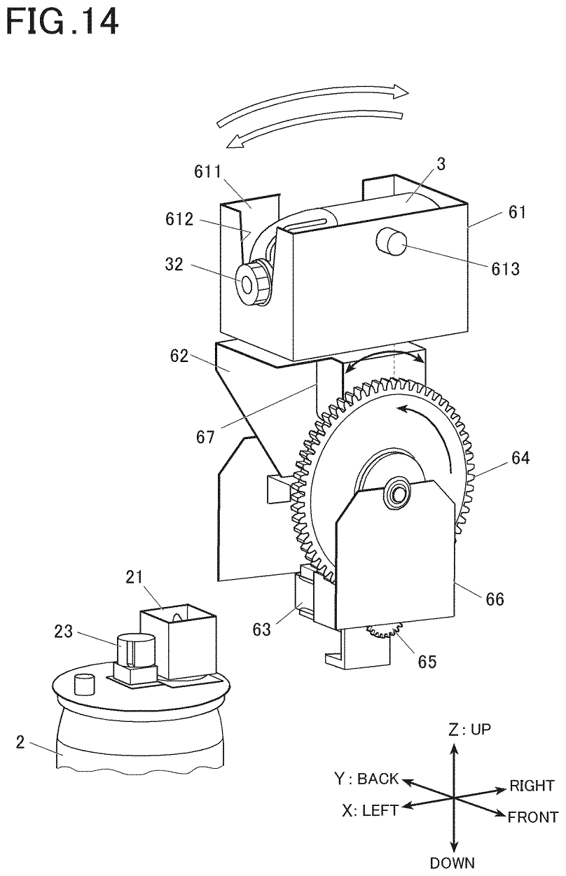

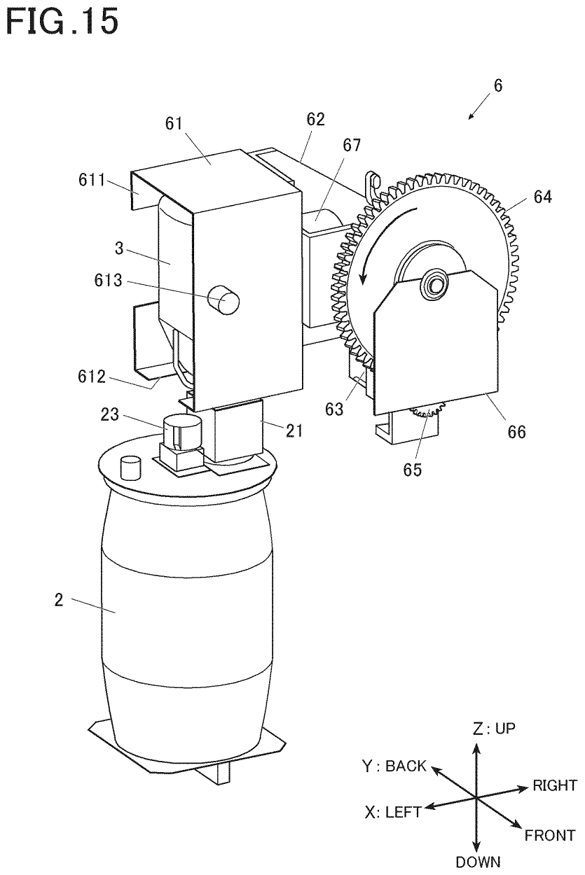

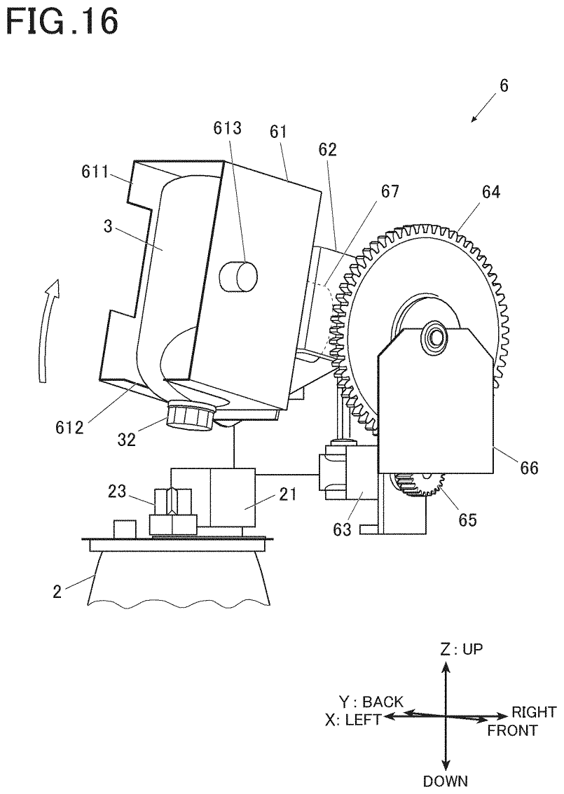

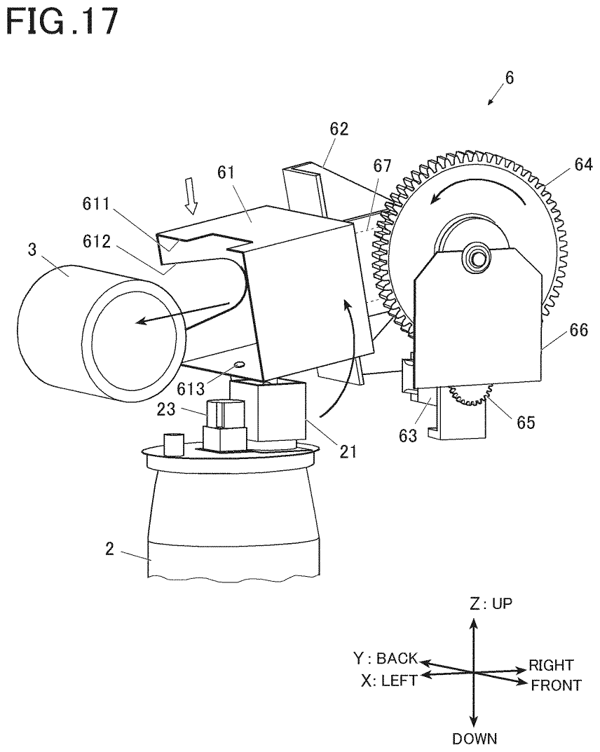

By the combination of the swinging action of the arm 62 and the rotating action of the holding frame 61, the conveyer 6 can perform various actions such as a receiving action of the refill container 3 illustrated in FIG. 12, a stirring action of the refill container 3 illustrated in FIG. 14, a loading action of the refill container 3 into the ink tank 2 as illustrated in FIG. 15, an unloading action of the empty refill container 3 after the ink supply as illustrated in FIG. 16 and a disposal action of the empty refill container 3 after the ink supply as illustrated in FIG. 17. Each of these actions will be described in order. The following actions are all performed under the control of the controller 9.

First, the conveyer 6 performs the receiving action of the refill container 3 as illustrated in FIG. 12.

The conveyer 6 is disposed at the left side of the lift mechanism 5. At the receiving position of the conveyer 6, the holding frame 61 is in a position in which the swinging end of the arm 62 points to the right (precisely, slightly upward from the right). The controller 9 makes the holding frame 61 stand by at the receiving position, and conveys the refill container 3 upward by the lift mechanism 5. As described above, when the lift plate 51 is elevated over the regulation bar 55 of the lift mechanism 5, the refill container 3 rolls to the left beyond the regulation bar 55 and is laid in the holding frame 61.

Once the refill container 3 is laid, the bottle holding actuator 613 of the holding frame 61 projects a pin to lock the refill container 3.

Then, as illustrated in FIG. 13, the bottle rotating motor 67 rotates the holding frame 61 under the control of the controller 9 so that the longitudinal direction of the holding frame 61 and the refill container 3 is in the tangential direction of the swing locus of the arm 62.

After the receiving action of receiving the refill container 3, the arm 62 swings upward, passes through the uppermost position and then swings downward so as to convey the refill container 3 to the loading position of the ink tank 2.

As illustrated in FIG. 14, the stirring action is performed before reaching the loading position when the refill container 3 passes through the uppermost position.

At the uppermost position of the arm 62, the tangential direction of the swing locus is parallel to the X-axis direction. Accordingly, at the uppermost position, the longitudinal direction BL of the refill container 3 is parallel to the X-axis direction. The controller 9 performs the stirring action of the refill container 3 by reciprocally swinging the arm 62 plural times with a predetermined amplitude within a range that passes through the uppermost position of the arm 62. That is, the controller 9 performs stirring by a reciprocating movement in the longitudinal direction BL of the refill container 3 in a position in which the longitudinal direction BL is in the X-axis direction (lateral direction, horizontal direction).

In the following, described is the significance of the stirring by the reciprocating movement in the longitudinal direction BL of the refill container 3 in a position in which the longitudinal direction is in the lateral or horizontal direction.

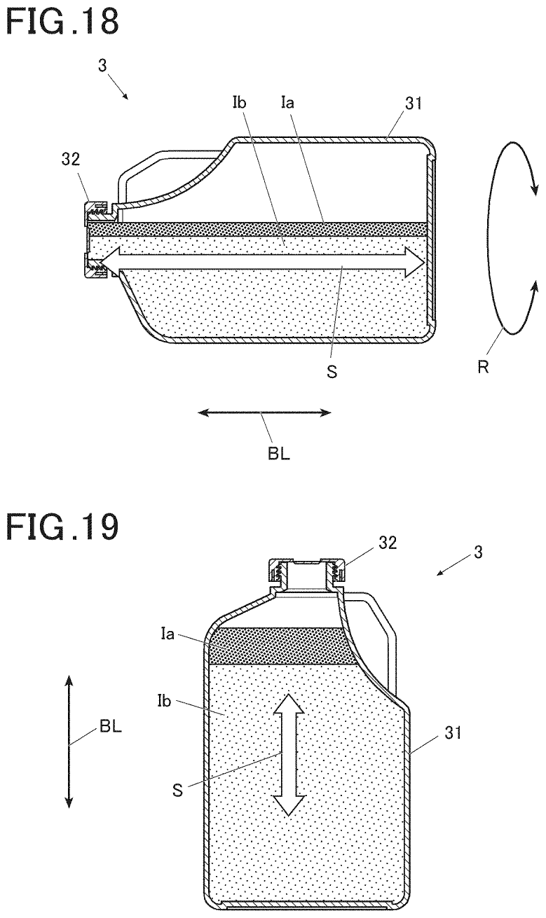

FIG. 18 is a cross-sectional view illustrating the state of ink in the refill container 3 in a position in which the longitudinal direction BL of the refill container 3 is in the horizontal direction, and FIG. 19 is a cross-sectional view illustrating the state of the ink in the refill container 3 in a position in which the longitudinal direction BL of the refill container 3 is in the vertical direction.

As described above, when the liquid in the refill container 3 is ink or the like that tends to be separated into an ink component and the other components such as additives, the liquid may sometimes be separated to the ink layer Ib and the separated layer Ia during transportation of the refill container 3. Comparing the position in which the longitudinal direction BL of the refill container 3 is in the horizontal direction and the position in which the longitudinal direction BL is in the vertical direction, when the liquid is in a separated state, the bottle-shaped refill container 3 has a larger cross-sectional area of the internal space in the position in which the longitudinal direction BL is in the vertical direction than in the position in which the vertical direction BL is in the horizontal direction. Accordingly, the layer thickness of the separated layer Ia separated from the ink component is thinner in the position in which the longitudinal direction BL is in the horizontal direction.

In the stirring action, the thinner the layer thickness of the separated layer Ia, the more effectively the stirring tends to be performed since the layered state is broken. Further, the stirring tends to be more effective to break the layered state when the reciprocating movement is parallel to the separated layer Ia (the direction of the arrow S in FIG. 18) than when the reciprocating movement is perpendicular to the separated layer Ia (the direction of the arrow S in FIG. 19).

Since the stirring action of the refill container 3 is performed by the reciprocating swing within the range that passes through the uppermost position of the arm 62, the stirring is performed in the direction parallel to the separated layer Ia in a state in which the separated layer Ia is thin. Accordingly, the contained ink is effectively stirred, and the ink can be supplied to the ink tank 2 in a sufficiently stirred state in which separation of the ink component from other components such as additives is reduced.

As used herein, “lateral” does not have to be completely horizontal, and it is only required that the layer thickness of the separated layer Ia in the refill container 3 in the lateral position is thinner than the layer thickness of the separated layer Ia in the refill container 3 in the vertical position. The same applies to the above-mentioned “sideways” of the storage 4.

The conveyer 6 may be configured to convey the refill container 3 such that after the receiving action of the refill container 3, the arm 62 swings downward, passes through the lowermost position and reaches the ink tank 2. In this case, the stirring action of the refill container 3 may be performed by the reciprocating swing of the arm 62 within the range that passes through the lowest position.

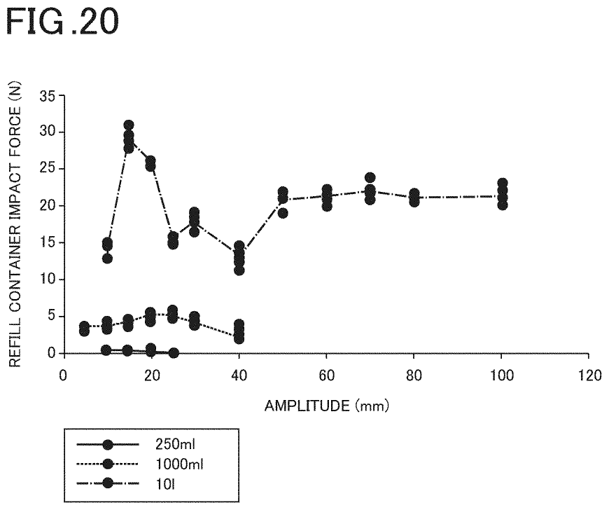

FIG. 20 is a diagram showing the relationship between the amplitude and the impact force generated in the refill container 3, which was obtained in a test of the stirring action in the longitudinal direction BL of the refill container 3 in a position in which the longitudinal direction BL is in the horizontal direction.

In the test for obtaining this diagram, the stirring action is performed at the same moving speed regardless of the amplitude of the stirring action. Accordingly, the vibration frequency decreases in inverse proportion to the increasing amplitude.

Further, in the test for obtaining this diagram, the measurement was performed on the refill containers 3 respectively having capacities of 250 ml, 1000 ml and 10 l, and a detection element such as a strain gauge or an acceleration sensor for detecting the impact force was attached to one end in the longitudinal direction BL of each refill container 3.

As a result, it was revealed that the impact force does not increase as the amplitude increases, but the impact force generated in the refill container 3 tends to be high when the refill container 3 is stirred with at a specific amplitude. Further, it was found that the relationship between the amplitude and the impact force is more prominent when the capacity of the refill container 3 is larger. As described above, the amplitude and the vibration frequency are correlated to each other in this test. Accordingly, it was found that the vibration frequency and the impact force also have a relationship that the impact force is high at a specific vibration frequency.

Considering the above-described relationship between the amplitude and the impact force or between the vibration frequency and the impact force, the ink supply apparatus 1 is configured such that one, two or all of the amplitude, the vibration frequency and the operation speed (moving speed of the refill container 3 by the swinging arm 62) in the stirring action by the conveyer 6 are configurable through a configuration input interface 94 provided to the controller 9.

Then, the controller 9 controls the bottle conveying motor 63 so that the stirring action is performed according to the settings.

The number of reciprocations in the stirring may be configurable through the configuration input interface 94. In that case, the controller 9 controls the bottle conveying motor 63 so that the refill container 3 reciprocates according to the set number of times.

Further, the ink stirring action is more effective when it includes not only the stirring in the longitudinal direction BL of the refill container 3 that is performed in the sideways position of the refill container 3 in which the separated layer Ia is thin, but also a reciprocating rolling movement around the longitudinal direction BL of the refill container 3 as illustrated by the arrow R in FIG. 18.

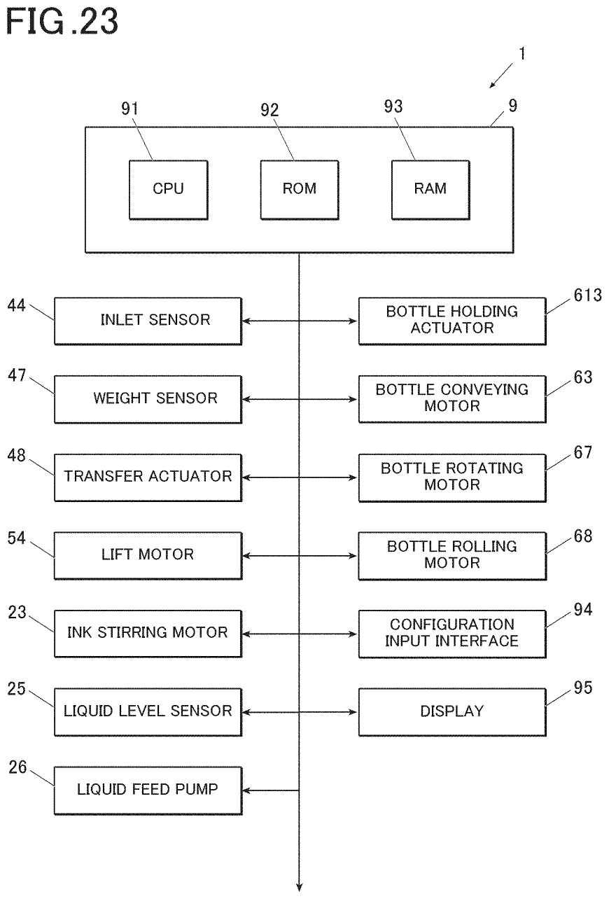

For this purpose, a rolling roller (not shown in the figures) that comes in contact with the outer peripheral surface of the refill container 3 and a bottle rolling motor 68 (see FIG. 23) that rotary drives the rolling roller are provided inside the holding frame 61. The bottle rolling motor 68 is controlled by the controller 9. During the stirring action by the bottle conveying motor 63, the controller 9 also drives the bottle rolling motor 68 to reciprocally roll the refill container 3 around the longitudinal direction BL of the refill container 3.

After the stirring action of the refill container 3, the arm 62 swings downward and reaches the refill position of the ink tank 2 where the swing end points to the left, and the loading action is performed in this position.

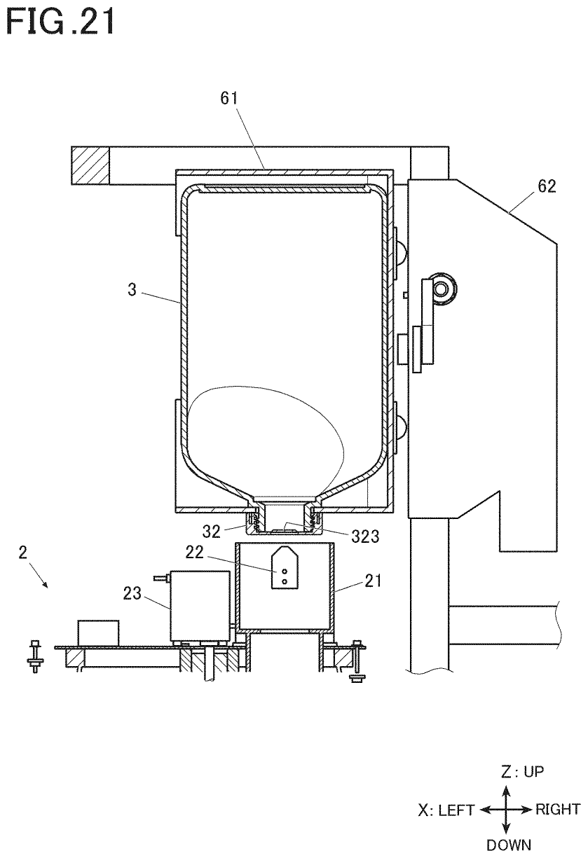

As illustrated in FIG. 21, a cylindrical refill port 21 communicated to the inside of the ink tank 2 is provided at the refill position in the upper part of the ink tank 2. The inner diameter of the refill port 21 is larger than the outer diameter of the lid 32 of the refill container 3, and the lid 32 of the refill container 3 can be inserted inside.

Further, a needle tooth opener 22 as an opener having an upward sharp shape is provided at the inner center of the refill port 21. For example, the needle tooth opener 22 is formed in the shape of a bamboo spear. When the lid 32 of the refill container 3 is inserted into the refill port 21 from above, the needle tooth opener 22 abuts the recess 323 of the closing surface 321 of the lid 32. Due to the shape of the tip, when the needle tooth opener 22 abuts the recess 323, the pressing load is concentrated on the tip and the fragile portion 324 breaks from one point. The broken portion spreads over the entire fragile portion 324, and the entire recess 323 is pushed inward. The entire opening 322 is thus opened. Then, all the ink in the refill container 3 flows out from the opening 322 into the ink tank 2 through the refill port 21.

In order to transfer all the ink in the refill container 3 into the ink tank 2, the loaded state is maintained for a sufficient period of time.

When the replenishment of the ink from the refill container 3 is completed, as illustrated in FIG. 16, the arm 62 swings upward to perform the unloading action so that the lid 32 of the refill container 3 is pulled out of the refill port 21 of the ink tank 2. The amount of this swing movement is not particularly limited, but is sufficient for the lid 32 of the refill container 3 to be pulled out of the refill port 21. Further, since the disposal action described later is performed in a state in which the arm 62 is inclined downward, it is preferable that the amount of swing movement in the unloading action is small.

Once the unloading action of unloading the refill container 3 is completed, as illustrated in FIG. 17, the disposal action of discarding the empty refill container 3 after the ink supply is performed.

In the disposal action, the refill container 3 is discharged through the inlet/outlet 611 of the holding frame 61. The holding frame 61 is rotated by 90° by the bottle rotating motor 67, and the arm 62 is swung so that a downward slope is formed at the swinging end of the arm 62. Along with this, the pin of the bottle holding actuator 613 is retracted so that the refill container 3 is released.

As a result, the refill container 3 in the holding frame 61 rolls out and is discarded to the discharge portion at the destination.

In the disposal action of the refill container 3, the angle of the arm 62 is limited to the downward slope. In order to avoid this, an actuator for pushing out the refill container 3 from the holding frame 61 may be provided. With such an actuator, the refill container 3 can be discharged even if the arm 62 does not have a downward slope, which can reduce the limitation on the angle of the arm 62.

### [Ink Tank]

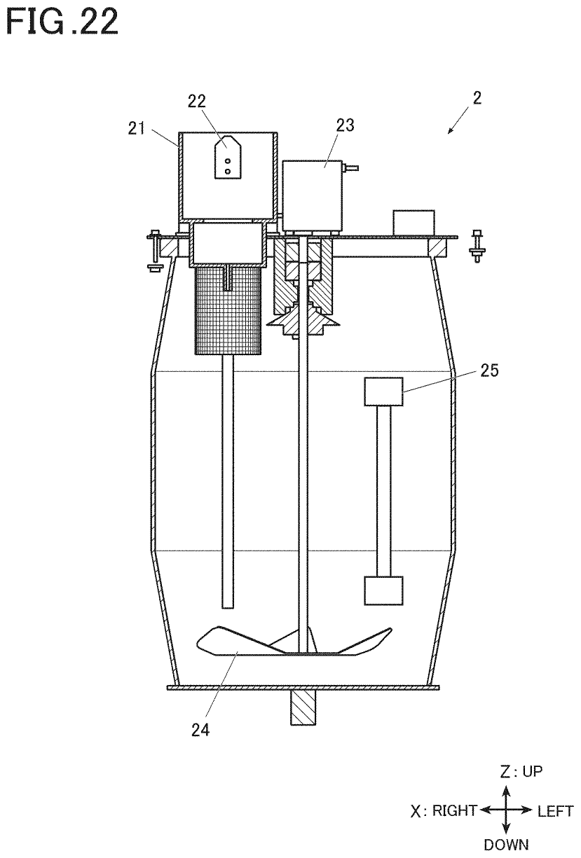

FIG. 21 is a cross-sectional view illustrating the structure of the upper part of the ink tank 2, and FIG. 22 is a cross-sectional view illustrating the overall structure of the ink tank 2.

As described above, the ink tank 2 includes a refill port 21 at the upper part and further includes an ink stirring motor 23 at the center of the upper part for rotary driving a stirring screw 24 disposed inside the tank.

Further, inside the ink tank 2, for example, a liquid level sensor 25 for detecting the amount of ink inside is provided, which is a float sensor for example. The liquid level sensor 25 is not limited to a float sensor, and any sensor capable of detecting that the ink in the ink tank 2 is equal to or less than a specified level or detecting the amount of liquid itself can be used as the liquid level sensor 25.

The ink stirring motor 23 is controlled by the controller 9. For example, the ink stirring motor 23 may periodically perform stirring for a specified period of time, or may perform stirring when ink is replenished from the refill container 3, or may perform stirring when the ink level exceeds a specified level or falls below a specified level. The ink stirring motor 23 may perform stirring at a part or all of these stirring timings combined.

Further, the ink tank 2 includes a supply pipe (not shown in the figures) for feeding the ink therein to the inkjet recording apparatus and a liquid feed pump 26 (see FIG. 23) that applies a supply pressure to the ink in the supply pipe.

### [Control Configuration of Ink Supply Apparatus]

FIG. 23 is a block diagram illustrating a control configuration of the ink supply apparatus 1.

As shown in the figure, in the ink supply apparatus 1, the controller 9 includes a CPU 91 (Central Processing Unit), a ROM 92 (Read Only Memory), a RAM (Random Access Memory) 93 and the like. The controller 9 controls the operation of each component of the ink supply apparatus 1.

The controller 9 reads a program from the ROM 92, develops the program in the RAM 93 and executes the program by the CPU 91, so as to perform various operation controls.

A controller of the inkjet recording apparatus may be configured to function as the controller 9 of the ink supply apparatus 1.

The controller 9 is connected via a bus to the inlet sensor 44, the weight sensor 47, the transfer actuator 48, the lift motor 54, the ink stirring motor 23, the liquid level sensor 25, the liquid feed pump 26, the bottle holding actuator 613, the bottle conveying motor 63, the bottle rotating motor 67, the bottle rolling motor 68, the configuration input interface 94, the display 95, and the like.

The controller 9 is configured such that the CPU 91 reads and executes various programs and data from a storage device such as the ROM 92 according to the processing to be performed, and controls the operation of each component of the ink supply apparatus 1 according to the processing.

The operation control performed by the controller 9 will be described below. The operation control already mentioned in the description of each component will be omitted.

The replenishment control of replenishing ink to the ink tank 2 performed by the controller 9 will be described.

In the above control, when the liquid level sensor 25 of the ink tank 2 detects a predetermined decrease of ink in the ink tank 2, the controller 9 performs the replenishment control. Then, the refill container(s) 2 in the storage 4 is conveyed to the refill position of the ink tank 2 in order from the refill container 3 that was loaded first (hereinafter, the first refill container 3), and the ink is replenished.

The predetermined decrease in the ink level in the ink tank 2 may mean a decrease of the liquid from the full level by the amount of ink in one refill container 3 or detection of a specific ink level indicating that a small amount of ink is left in the ink tank 2. In the former configuration, the controller 9 conveys one refill container 3 to the refill position of the ink tank 2 and replenishes the ink. In the latter configuration, the controller 9 may convey one refill container 3 to the replenishment position of the ink tank 2, and replenishment is not performed until the specified level indicating a small amount of ink is left in the ink tank 2 is detected again. Alternatively, the controller 9 may repeat conveying the ink container 3 and replenishing the ink for plural times until the ink tank 2 becomes almost full.

To convey each refill container 3 to the refill position of the ink tank 2, the above-described actions are sequentially performed, which includes all of: the transferring action of transferring the first refill container 3 to the lift mechanism 5 by the transfer actuator 48 of the storage 4; the conveyance to the receiving position of the conveyer 6 by the lift motor 54 of the lifting mechanism 5; the receiving action (FIG. 12) of receiving the refill container 3 by the conveyer 6; the stirring action (FIG. 14) of stirring the refill container 3 by the conveyer 6; the loading action (FIG. 15) of loading the refill container 3 to the ink tank 2 by the conveyer 6; the unloading action (FIG. 16) of unloading the empty refill container 3 by the conveyer 6 after the ink supply; and the disposal action (FIG. 17) of discarding the empty refill container 3 by the conveyer 6 after the ink supply.

When a plurality of refill containers 3 is conveyed for the replenishment, the above actions are repeatedly performed.

### [Example of Ink Supply System]

An example of an ink supply system as a liquid supply system will be described. The ink supply system is composed of a plurality of ink supply apparatuses 1 and supplies ink to an inkjet recording apparatus.

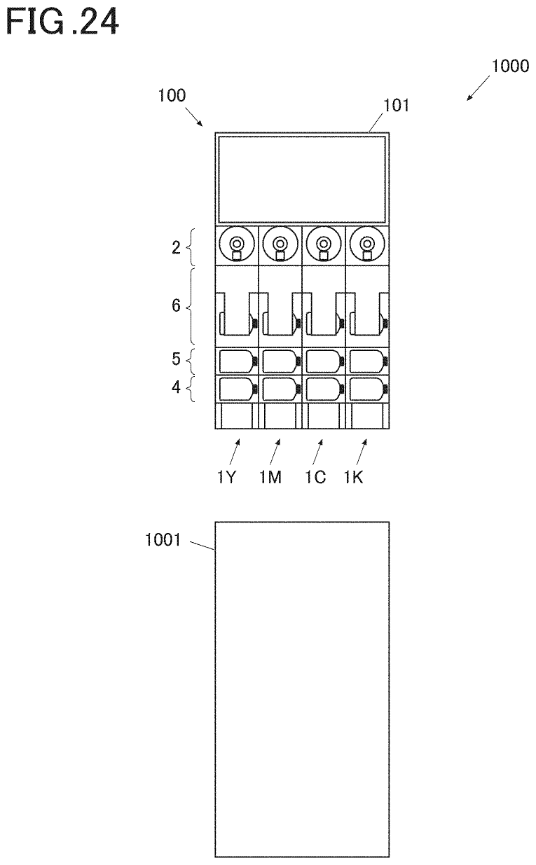

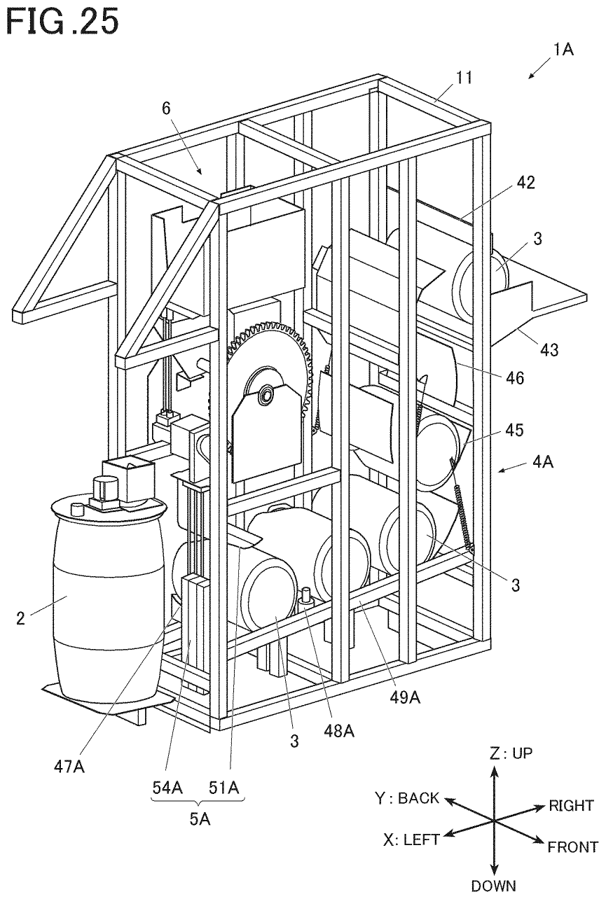

FIG. 24 is a plan view of an inkjet recording system 1000 including an ink supply system 100 and an inkjet recording apparatus 1001, illustrating the configuration and layout thereof.

For example, when the inkjet recording apparatus 1001 requires inks of the colors Y (yellow), M (magenta), C (cyan), and K (black), the inkjet recording system 1000 is configured such that the ink supply system 100 includes an ink supply apparatus 1Y for Y (yellow), an ink supply apparatus 1M for M (magenta), an ink supply apparatus 1C for C (cyan), and an ink supply apparatus 1K for K (black). Each of the ink supply apparatuses 1Y, 1M, 1C, and 1K has the same configuration as the above-described ink supply apparatus 1, and the inks to supplied to the inkjet recording apparatus 1001 correspond to the respective colors.

In the inkjet recording system 1000, the ink supply system 100 is installed next to the inkjet recording apparatus 1001.

Further, since each of the ink supply apparatuses 1Y, 1M, 1C, and 1K has a substantially rectangular shape that is long in the X-axis direction in a plan view, it is possible to save space by arranging the ink supply apparatuses 1Y, 1M, 1C and 1K side by side in the short-side direction in the plan view. In this case, it is preferable to install a waste bin 101 for discarding empty refill containers 3 at the end of each ink supply apparatus 1Y, 1M, 1C, 1K at the side of the ink tank 2.

### [Technical Advantageous Effect of First Embodiment]

The ink supply apparatus 1 includes the conveyer 6 that loads the refill container 3 to the refill position of the ink tank 2 to replenish the ink. This can release an operator from a work of attaching the refill container 3 to the ink tank 2 and pouring ink from the refill container 3 into the ink tank 2. Therefore, it becomes possible to significantly reduce the workload.

Further, it becomes possible to increase the capacity of the ink tank 2 and the refill container 3.

The ink supply apparatus 1 includes the storage 4 for storing a plurality of refill containers 3. This allows loading a plurality of refill containers 3 at a time. Therefore, it is possible to reduce the frequency of work and the workload.

The ink supply apparatus 1 includes the lift mechanism 5. This allows the refill container 3 to be conveyed upward. Even when the refill position is high due to the increased size of the ink tank 2, the refill container 3 can be easily conveyed.

The ink supply apparatus 1 includes the controller 9 that controls the conveyer 6 to load the refill container 3 in the storage 4 to the refill position according to the amount of ink left in the ink tank 2. This can reduce the burden of monitoring the amount of remaining ink, and it is possible to further reduce the workload.

In the ink supply apparatus 1, the conveyer 6 loads the refill container 3 to the refill position of the ink tank 2 with the discharge port 322 facing downward. This allows the ink supply apparatus 1 to control the ink supply from the refill container 3 to the ink tank 2. Therefore, it is possible to further reduce the workload.

The ink supply apparatus 1 includes the needle tooth opener 22 for opening the discharge port 322 of the refill container 3 at the refill position of the ink tank 2. This allows the ink supply apparatus 1 to open the refill container 3. Therefore, it is possible to further reduce the workload.

The discharge port 322 of the refill container 3 has a fragile portion 324 that can be opened by a relative pressing force from the needle tooth opener 22 generated when the refill container 3 is loaded into the refill position by the conveyer 6. Since the refill container 3 is opened at the time of loading, it is possible to efficiently replenish the ink.

The conveyer 6 performs the stirring action at any point in the conveyance path between the receiving position and the refill position. Since the stirring action is completed during the conveyance, it is possible to efficiently replenish the ink.

The conveyer 6 performs the stirring action by the reciprocating movement in the longitudinal direction BL of the refill container 3 in a position that the longitudinal direction BL is in the lateral (horizontal) direction. This allows the stirring to be performed along the ink separated layer Ia in a state in which the cross-sectional area of the refill container 3 is large and the ink separated layer Ia is thin. Accordingly, it is possible to refill the ink tank 2 with more effectively stirred ink.

Further, the ink supply apparatus 1 includes the configuration input interface 94 for setting the amplitude, operation speed, vibration frequency, etc. of the reciprocating movement in the longitudinal direction BL of the refill container 3. Since the controller 9 controls the conveyer 6 to perform the stirring action by the reciprocating movement in the longitudinal direction BL of the refill container 3 according to the settings made on the configuration input interface 94. Accordingly, it is possible to select more suitable amplitude, operating speed or vibration frequency according to various conditions such as the shape and capacity of the refill container 3 and the ink viscosity. Therefore, it is possible to perform the stirring action more effectively.

The conveyer 6 performs the stirring action before the ink tank 2 reaches the refill position. This allows the refill container 3 to be immediately loaded into the refilling position of the ink tank 2 after the stirring. Therefore, it is possible to replenish the ink in a good condition immediately after being stirred.

In addition to the loading action of loading the refill container 3 into the refill position, the conveyer 6 can perform the disposal action of discarding the refill container 3 after the ink supply. Therefore, it is possible to further reduce the workload.

Further, the conveyer 6 can change the direction of the held refill container 3 by driving the bottle rotating motor 67. This allows the direction of the refill container 3 to be suitably adjusted in the various actions such as the receiving action of receiving the refill container 3, the stirring action of stirring the refill container 3, the loading action of loading the refill container 3 to the ink tank 2, the unloading action of unloading the empty refill container 3 after the ink supply, and the disposal action of discarding the empty refill container 3 after the ink supply. Therefore, it is possible to perform various operations effectively and correctly.

The storage 4 of the ink supply apparatus 1 stores the refill containers 3 in a position in which the longitudinal direction BL of the refill containers 3 is in the lateral direction.

This allows the ink to be stored in a state in which the cross-sectional area in the refill container 3 is large and the ink separated layer Ia is thin (see FIG. 18). Compared to storing the ink in a state in which the ink separated layer Ia is thick, it is possible to perform better stirring when the refill container 3 is stirred by the stirring action. Therefore, it is possible to refill the ink tank 2 with the well-stirred ink.

At the inlet for loading the refill container 3 into the storage 4, the regulation frame 42 is provided to allow the refill container 3 to pass through in a position in which the longitudinal direction is in the lateral direction. This can eliminate the need of a configuration that changes the direction of the refill container 3 sideways in the storage 4.

The storage 4 stores a plurality of refill containers 3 in a state in which the refill containers 3 are arranged in the order of having been loaded through the inlet, and the stored refill containers 3 are transferred to the conveyer 6 in the order of having been loaded into the storage 4.

Accordingly, the refill containers 3 are loaded to the ink tank 2 in the order of having been loaded to the storage 4. This can reduce variation of the storage period between the refill containers 3, and it is possible to reduce separation of the ink to be replenished to the ink tank 2.

Further, when the handle 313A is provided in the middle part in the longitudinal direction BL of the refill container 3, the refill container 3 can be loaded more easily in a position in which the longitudinal direction BL is in the horizontal direction.

The refill container 3 has the tapered portion 312 in which the cross-sectional area decreases toward the ink discharge port 322 at one end in the longitudinal direction BL. This can reduce the residual ink in the refill container 3, and it is possible to replenish the ink with less waste.

The ink supply system 100 includes the ink supply apparatuses 1Y, 1M, 1C, and 1K individually for respective inks, and can correctly supply the inks to the inkjet recording apparatus 1001 that requires multiple inks.

### Second Embodiment

Hereinafter, a second embodiment of the present invention will be described with reference to the drawings.

In this embodiment of the present invention, an ink supply apparatus 1A as a liquid supply apparatus is illustrated. The ink supply apparatus 1A supplies ink to an inkjet recording apparatus as a liquid ejection apparatus that ejects ink (liquid).

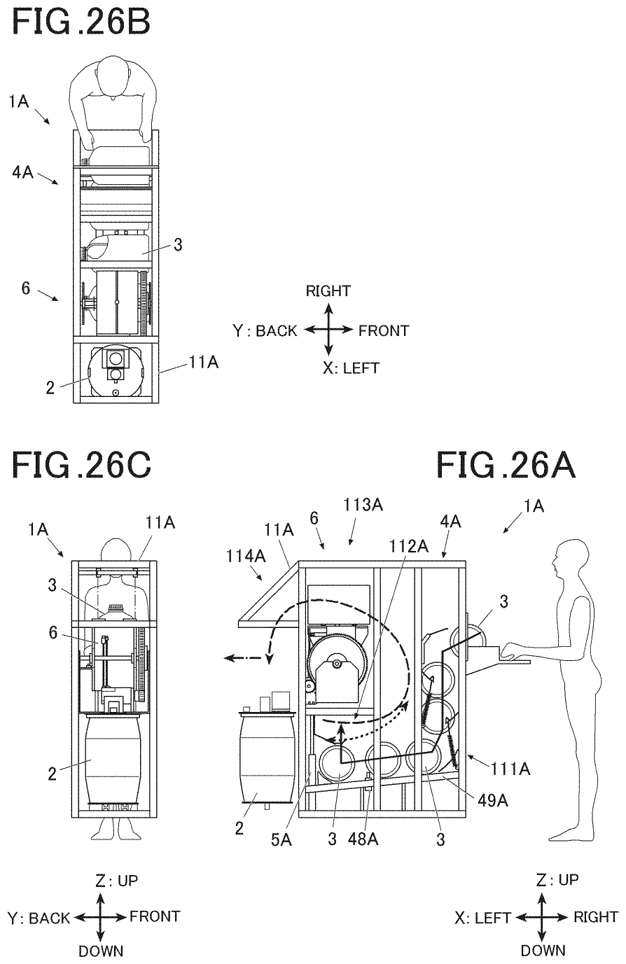

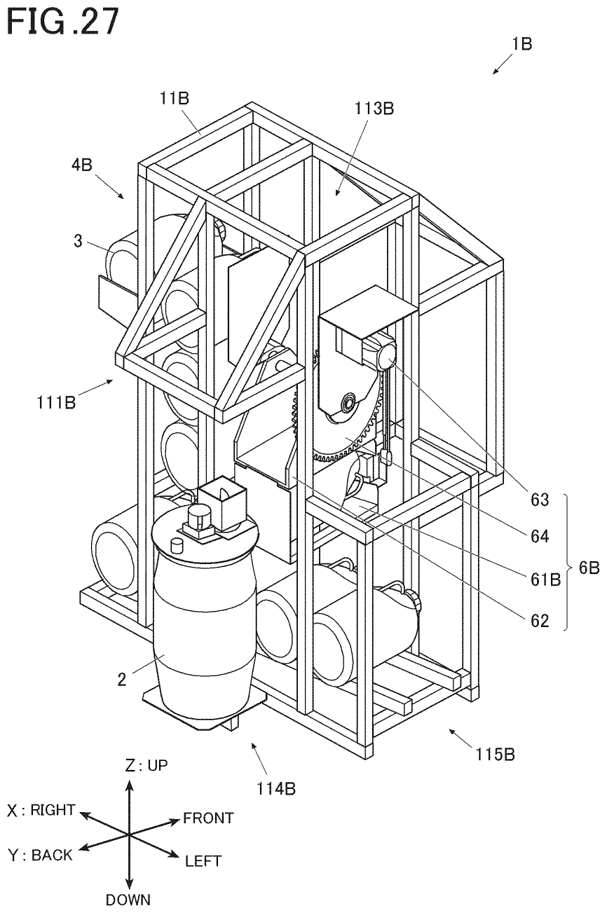

FIG. 25 is a perspective view of the ink supply apparatus 1A, FIG. 26A is a front view of the ink supply apparatus 1A, FIG. 26B is a left side view thereof, and FIG. 26C is a plan view thereof.

Regarding the ink supply apparatus 1A, the same reference numerals are denoted to the same components as the components of the above-described ink supply apparatus 1, and repetitive description will be omitted. The differences from the ink supply apparatus 1 will be mainly described.

In the above-described ink supply apparatus 1, the refill containers 3 stored in the storage 4 are arranged in the Z-axis direction. The ink supply apparatus 1A is different from the ink supply apparatus 1 in that a storage 4A includes a portion in which the refill containers 3 are arranged in the direction that is slightly inclined downward to the left with respect to the X-axis direction as well as a portion in which the refill containers 3 are arranged in the Z-axis direction.

The storage 4A includes a slope 49A that is slightly downward to the left with respect to the X-axis direction. At the end of the slope 49A, a transfer actuator 48A for restricting entry of the refill container 3 to the lift mechanism 5A is provided. The transfer actuator 48A may be constituted by any device that can regulate passage of the refill container 3. In the embodiment, a linear actuator such as a solenoid that can stop and pass the rolling refill container 3 by protruding and retracting a pin is illustrated as an example.

Corresponding to the shape of the storage 4A, an installation area 111A of the frame 11A of the ink supply apparatus 1A for supporting the storage 4A extends from the right end of the frame 11A to the vicinity of the left end along the bottom.

Further, a lift mechanism 5A and an installation area 112A supporting the lift mechanism 5A are located above the left end of the installation area 111A for the storage 4A, and a conveyer 6 and an installation area 113A supporting the conveyer 6 are further located above the lift mechanism 5A. An installation area 114A that supports the ink tank 2 is almost the same as the above-described installation area 114.

The lift mechanism 5A stands by at the left end of the slope 49A of the storage 4A. The lift mechanism 5A includes a hook-shaped lift plate 51A that is movable upward, and a linear actuator 54A that moves up and down the lift plate 51A.

The above-described transfer actuator 48A of the storage 4A allows passage of the refill container 3 when the lift plate 51A of the lift mechanism 5A is located at the left end of the slope 49A. When the lift plate 51A is elevated, the transfer actuator 48A restricts passage of the refill container 3.

The conveyer 6 has the same configuration as the above-described conveyer 6 but is different in the receiving position of the refill container 3 from the lift mechanism 5A.

That is, in the receiving action of receiving the refill container 3 from the lift mechanism 5A, the holding frame 61 is in a position in which the arm 62 points downward when the conveyer 6 is in the receiving position. Accordingly, an inlet/outlet 611 of the holding frame 61 faces downward. This allows the holding frame 61 to accommodate the refill container 3 through the inlet/outlet 611 when the lift plate 51A is elevated along with the refill container 3 placed thereon.

Since the position of the holding frame 61 when the arm 62 points downward is defined as the receiving position of the conveyer 6, the arm 62 swings about 180° from the receiving position to the uppermost position to perform stirring. The actions after the stirring by the conveyer 6 are the same as those of the above-described ink supply apparatus 1.

The ink supply apparatus 1A has the same technical effects as the ink supply apparatus 1. Furthermore, the storage 4A has the portion in which the refill containers 3 are arranged in a direction of slightly downward slope to the left with respect to the X axis as well as the portion in which the refill containers 3 are arranged in the Z-axis direction. This allows the ink supply apparatus 1A to store a larger number of refill containers 3.

Along with this, the lift mechanism 5A is disposed below the conveyer 6. This eliminates the need of the installation space for the lift mechanism 5A between the storage 4A and the conveyer 6, and it is possible to reduce the size of the ink supply apparatus 1A in the X-axis direction.

The ink supply apparatus 1A has a substantially rectangular shape in a plan view that is long in the X-axis direction as with the above-described ink supply apparatus 1. When an ink supply system or an inkjet recording system is configured to include a plurality of ink supply apparatuses 1A, it is preferred that the plurality of ink supply apparatuses 1A are arranged as in the above-described ink supply system 100.

### Third Embodiment

Hereinafter, a third embodiment of the present invention will be described with reference to the drawings.

In this embodiment of the present invention, an ink supply apparatus 1B as a liquid supply apparatus is illustrated. The ink supply apparatus 1B supplies ink to an inkjet recording apparatus as a liquid ejection apparatus that ejects ink (liquid).

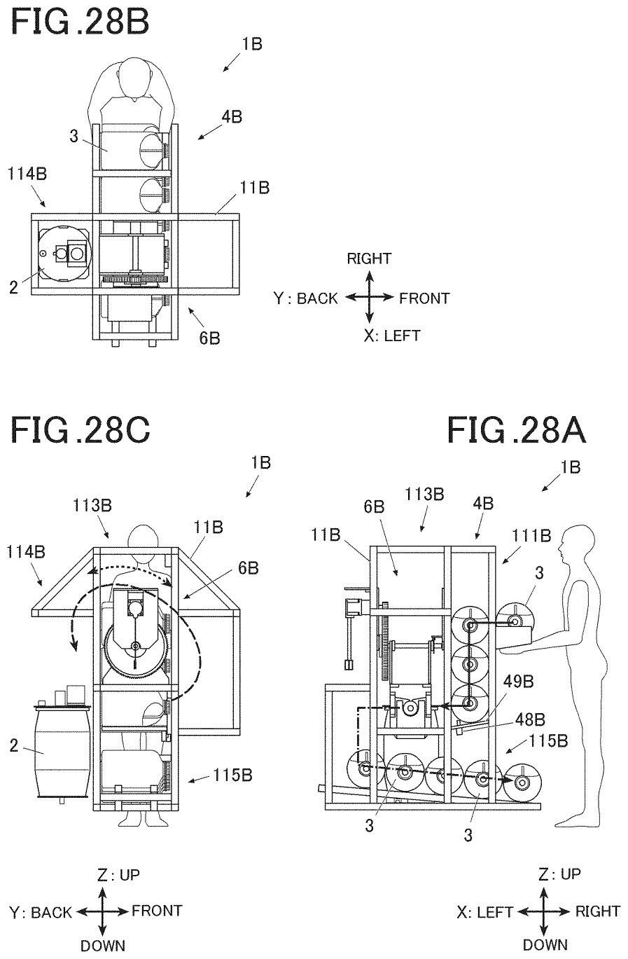

FIG. 27 is a perspective view of the ink supply apparatus 1B. FIG. 28A is a front view of the ink supply apparatus 1B, FIG. 28B is a left side view thereof, and FIG. 28C is a plan view thereof.

Regarding the ink supply apparatus 1B, the same reference numerals are denoted to the same components as those of the above-described ink supply apparatus 1, and repetitive description is omitted. The differences from the ink supply apparatus 1 will be mainly described.

The ink supply apparatus 1B includes a waste portion 115B that is disposed at the lower part of the frame 11B to accommodate empty refill containers 3 orderly.

Corresponding to this, an ink tank 2 and an installation area 114B therefor are located at a rear part of the frame 11B, the lift mechanism 5 is omitted, and an installation area 111B for a storage 4B and an installation area 113B for a conveyer 6B are located next to each other in the right and left.

Further, the conveyer 6B is configured such that the arm 62 is swingable around the X axis. The holding frame 61B is open not at the outer surface in the swing radial direction of the arm 62 but at one of the four surfaces along the swing radius of the arm 62 that is parallel to the longitudinal direction of the holding frame 61B, and the open side serves as an inlet/outlet of the refill container 3.

Therefore, by rotating the holding frame 61B by the bottle rotating motor 67 with the arm 62 facing downward so that the inlet/outlet faces to the right, the holding frame 61B can receive the refill container 3 directly from the storage 4B without using a lift mechanism.

Further, since the arm 62 is swingable about the X axis, the refill container 3 can be conveyed to the refill position of the ink tank 2 at the rear part of the frame 11B by swinging the arm 62 from the receiving position of the refill container 3 by 270° in the counterclockwise direction when the arm 62 is viewed from the left.

Further, also in the ink supply apparatus 1B, the stirring action of the refill container 3 can be performed at the uppermost position in the middle of the conveyance path from the receiving position for the refill container 3 to the refill position of the ink tank 2.

Further, in the ink supply apparatus 1B, after ink is supplied to the ink tank 2 and the refill container 3 becomes empty, the arm 62 is swung by 270° in the opposite direction (clockwise when viewed from the left) with the holding frame 61B in a 180°-rotated position. The holding frame 61B thus returns to the receiving position. At the receiving position, since the inlet/outlet of the holding frame 61B faces to the left, the empty refill container 3 is discharged from the holding frame 61B to the left, which is the opposite side from the storage 4B. For the discharge action from the holding frame 61B, it is preferable that an actuator that pushes the refill container 3 to the outside is provided.

The empty refill container 3 is stored in the waste portion 115B provided below the discharge direction. Since the waste portion 115B extends in the X-axis direction and has a downward slope from the left end to the right end, the waste portion 115B can store a plurality of discarded refill containers 3 in a state arranged in the X-axis direction.

The ink supply apparatus 1B has the same technical effects as the ink supply apparatus 1. Furthermore, with the waste portion 115B, the ink supply apparatus 1B can store a plurality of empty refill containers 3.

Furthermore, the refill container 3 is conveyed directly from the storage 4B to the conveyer 6B. This can eliminate a lift mechanism and save space. Accordingly, although the waste portion 115B is newly included as an additional component, it is possible to avoid an increase in the size of the apparatus.

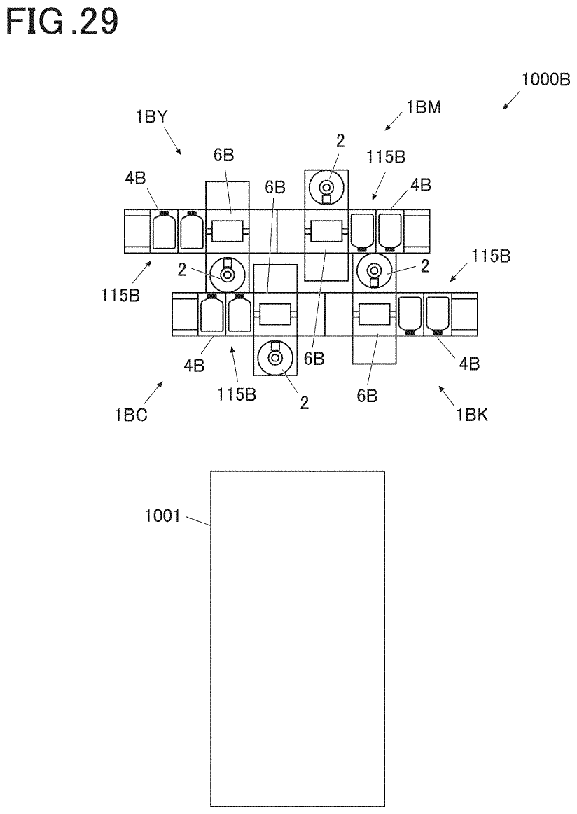

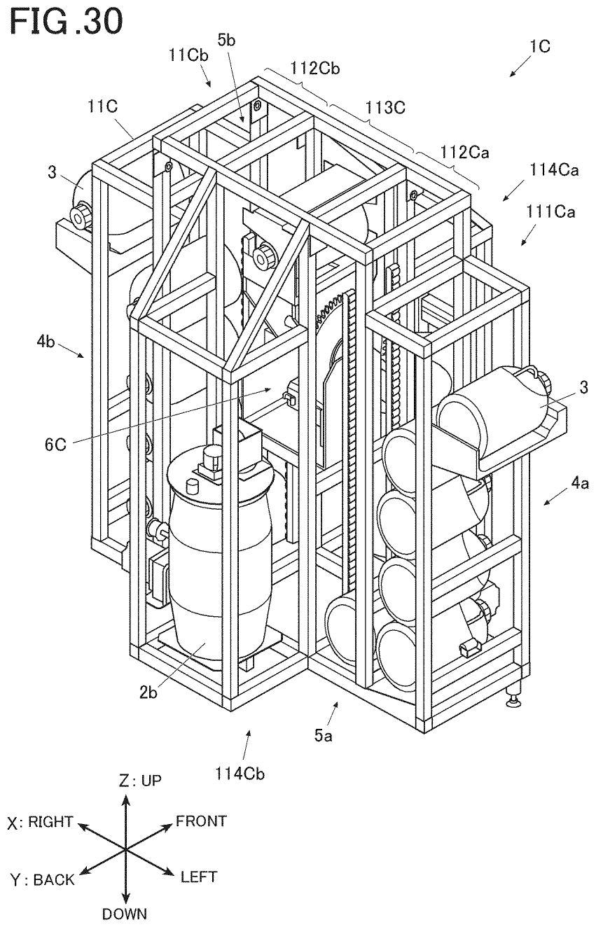

FIG. 29 is a plan view of an inkjet recording system 1000B including an ink supply system and an inkjet recording apparatus 1001, illustrating the configuration and layout thereof. The ink supply system includes ink supply apparatuses 1BY, 1BM, 1BC, and 1BK each of which has the same configuration as the ink supply apparatus 1B and which individually supply YMCK inks respectively.

In each of the ink supply apparatuses 1BY, 1BM, 1BC, and 1BK, an ink tank 2 is disposed to have a rectangular shape in a plan view that is long in the X-axis direction and has projections in the Y-axis direction. Accordingly, when the four ink supply apparatuses 1BY, 1BM, 1BC, and 1BK are arranged side by side in the Y-axis direction, a large space is required in the Y-axis direction.

To avoid this, the ink supply apparatuses 1BY, 1BM, 1BC, and 1BK are divided into two and two and arranged side by side in two rows, so that the parts that project in the Y-axis direction are offset in the X-axis direction. In this arrangement, it is possible to dispose the two rows of the ink supply apparatuses 1BY, 1BM, 1BC, and 1BK close to each other in the Y-axis direction and to save space.

Further, each of the ink supply apparatuses 1BY, 1BM, 1BC, and 1BK includes a waste portion 115B. This can eliminate the need of a waste bin for the ink supply system.

### Fourth Embodiment

Hereinafter, a fourth embodiment of the present invention will be described with reference to the drawings.

In this embodiment of the present invention, an ink supply apparatus 1C as a liquid supply apparatus is illustrated. The ink supply apparatus 1C supplies ink to an inkjet recording apparatus as a liquid ejection apparatus that ejects ink (liquid).

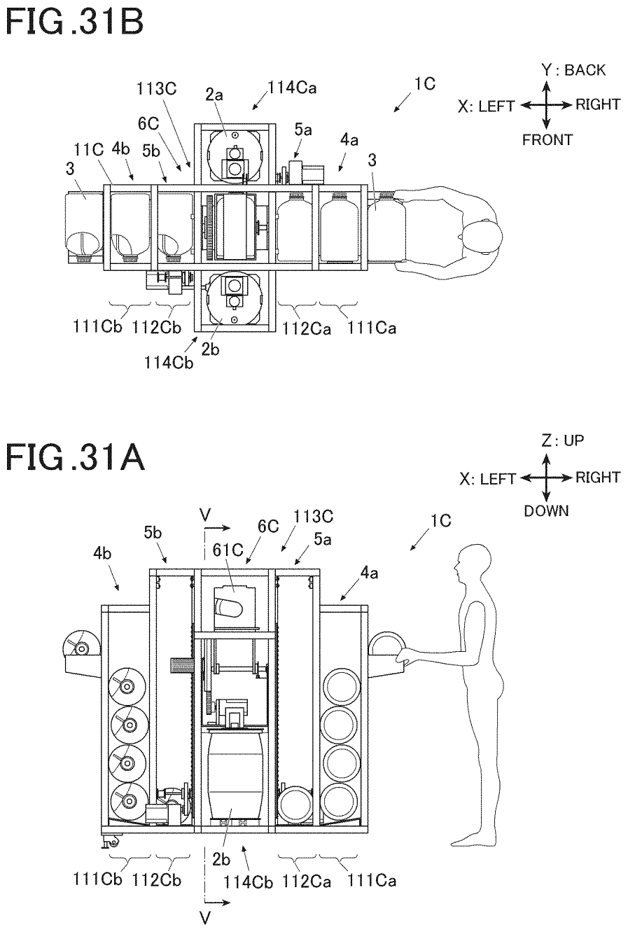

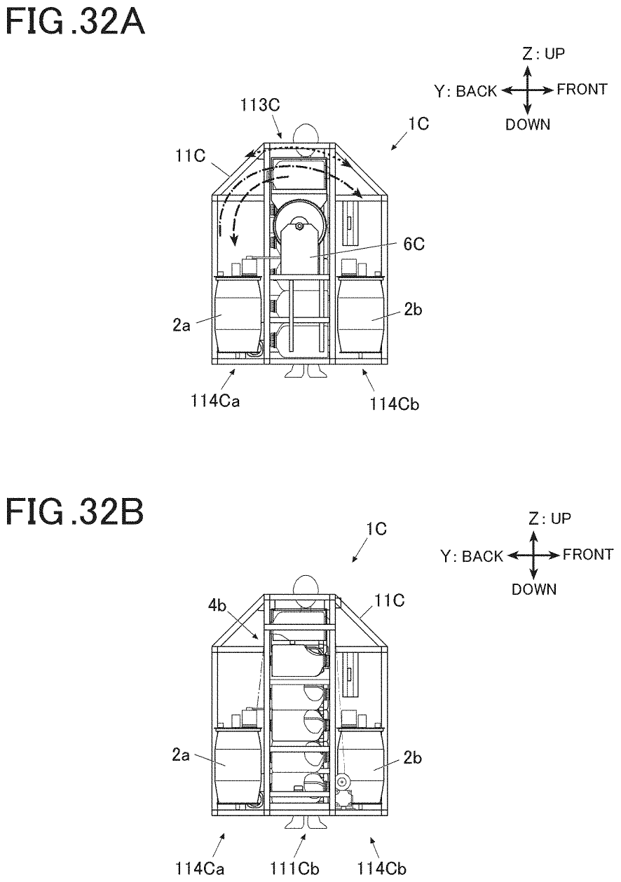

FIG. 30 is a perspective view of the ink supply apparatus 1C. FIG. 31A is a front view of the ink supply apparatus 1C, FIG. 31B is a plan view thereof. FIG. 32A is a cross-sectional view taken along the line V-V in FIG. 31A, and FIG. 32B is a left side view of the ink supply apparatus 1C.

Regarding the ink supply apparatus 1C, the same reference numerals are denoted to the same components as those of the above-described ink supply apparatus 1, and repetitive description is omitted. The differences from the ink supply apparatus 1 will be mainly described.

The ink supply apparatus 1C includes a first ink tank 2a and a second ink tank 2b as ink tanks, a first storage 4a and a second storage 4b as storages, and a first lift mechanism 5a and a second lift mechanism 5b as lift mechanisms.

A single conveyer 6C receives a refill container 3 from the first storage 4a via the first lift mechanism 5a and loads it into the refill position of the first ink tank 2a, and also receives a refill container 3 from the second storage 4b via the second lift mechanism 5b and loads it into the refill position of the second ink tank 2b.

In this configuration, for example, refill containers 3 for two colors of inks are prepared and stored respectively in the first storage 4a and the second storage 4b. The refill containers 3 can be conveyed to the first ink tank 2a and the second ink tank 2b of the corresponding colors to replenish the inks.

In the frame 11C, an installation area 113C for the conveyer 6C is provided in the center, an installation area 112Ca for the first lift mechanism 5a is provided on the right side thereof, and an installation area 111Ca for the first storage 4a is further provided on the right side thereof.

On the left side of the installation area 113C, an installation area 112Cb for the second lift mechanism 5b is provided, and an installation area 111Cb for the second storage 4b is further provided on the left side thereof.

On the back side of the installation area 113C, an installation area 114Ca for the first ink tank 2a is provided. On the front side of the installation area 113C, an installation area 114Cb for the second ink tank 2b is provided.

The first storage 4a and the second storage 4b have the same configuration as the above-described storage 4. The first lift mechanism 5a and the second lift mechanism 5b have the same configuration as the above-described lift mechanism 5. The first ink tank 2a and the second ink tank 2b have the same configuration as the above-described ink tank 2.

The conveyer 6C is configured such that the arm is swingable around the X axis, and the holding frame 61C is open not on the outer surface in the rotation radius of the arm but on one of the four surfaces along the rotation radius of the arm that is parallel to the longitudinal direction of the holding frame 61C. The open side serves as an inlet/outlet of the refill container 3.

By rotating the bottle rotating motor 67 with the arm pointing upward so that the inlet/outlet of the holding frame 61C faces to the right or left, it is possible to selectively receive the refill container 3 from the storage 4a or 4b via the lift mechanism 5a or 5b.

Further, the conveyer 6 can perform the stirring action of the refill container 3 by the reciprocally swinging the arm within the range including the receiving position of the refill container 3.

The arm is swingable about the X axis, and this allows the following actions to be performed. When the refill container 3 in the storage 4a is received, it is possible to convey the refill container 3 to the refill position of the first ink tank 2a located behind the frame 11C by swinging the arm from the receiving position of the refill container 3 by 90° in the counterclockwise direction when viewed from the left of the arm.

When the refill container 3 in the storage 4b is received, it is possible to convey the refill container 3 to the refill position of the second ink tank 2b located in front of the frame 11C by swinging the arm from the receiving position of the refill container 3 by 90° in the clockwise direction when viewed from the left of the arm.

In the ink supply apparatus 1C, the empty refill container 3 after ink supply to the first or second ink tanks 2a or 2b is unloaded and discharged through the inlet/outlet of the holding frame 61C. For the discharge operation from the holding frame 61C, it is preferable to provide an actuator that pushes out the refill container 3.

The ink supply apparatus 1C has the same technical effects as the ink supply apparatus 1. Further, the ink supply apparatus 1C store two types of inks to be supplied to the outside respectively in the first ink tank 2a and the second ink tank 2b. This allows the ink supply apparatus 1C to refill the first ink tank 2a and the second ink tank 2b properly with inks of corresponding colors from the refill containers 3 supplied from the first storage 4a and the second storage 4b.

The ink supply apparatus 1C selectively conveys the refill containers 3 of two types of inks by the single conveyer 6C. This can reduce the size of the apparatus and save space compared to a configuration in which two ink supply apparatuses are provided.

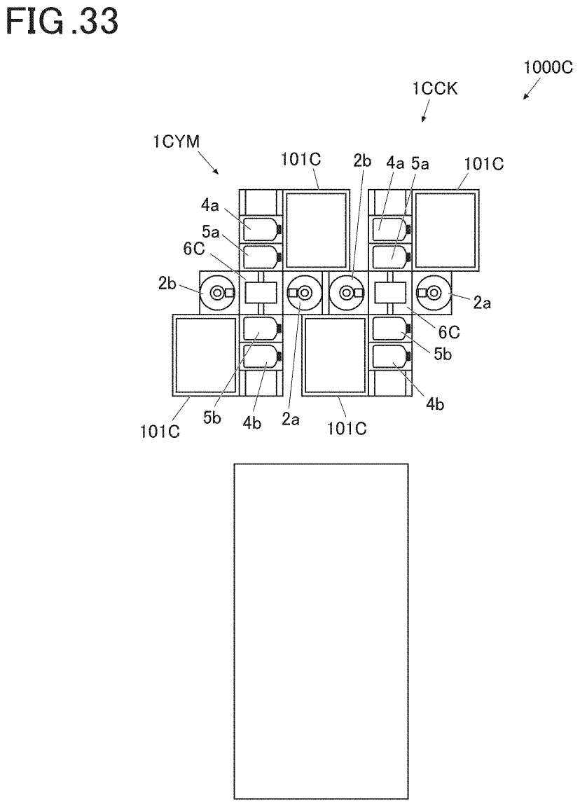

FIG. 33 is a plan view of an inkjet recording system 1000C composed of an ink supply system and an inkjet recording apparatus 1001, illustrating the configuration and layout thereof. The ink supply system includes ink supply apparatuses 1CYM and 1CCK each of which has the same configuration as the ink supply apparatus 1C and each of which supply two types of inks, which are Y and M inks and C and K inks respectively.

In each of the ink supply apparatuses 1CYM, 1CCK, the ink tanks 2a, 2b are arranged to have a rectangular shape in a plan view that is long in the X-axis direction and has protrusions in the Y-axis direction. When the two ink supply apparatuses 1CYM, 1CCK are arranged side by side in the Y-axis direction, empty spaces are formed next to the respective ink tanks 2a, 2b.

To effectively use space, four waste bins 101C for discarding the empty refill container 3 are provided in the respective empty spaces.

### Fifth Embodiment

Hereinafter, a fifth embodiment of the present invention will be described with reference to the drawings.

In the embodiment of the present invention, an ink supply apparatus 1D as a liquid supply apparatus is illustrated. The ink supply apparatus 1D supplies ink to an inkjet recording apparatus as a liquid ejection apparatus that ejects ink (liquid).

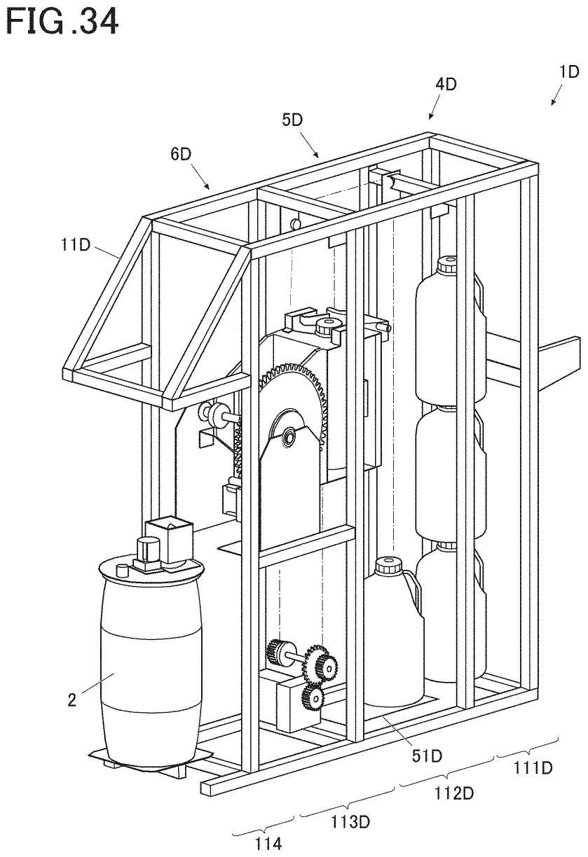

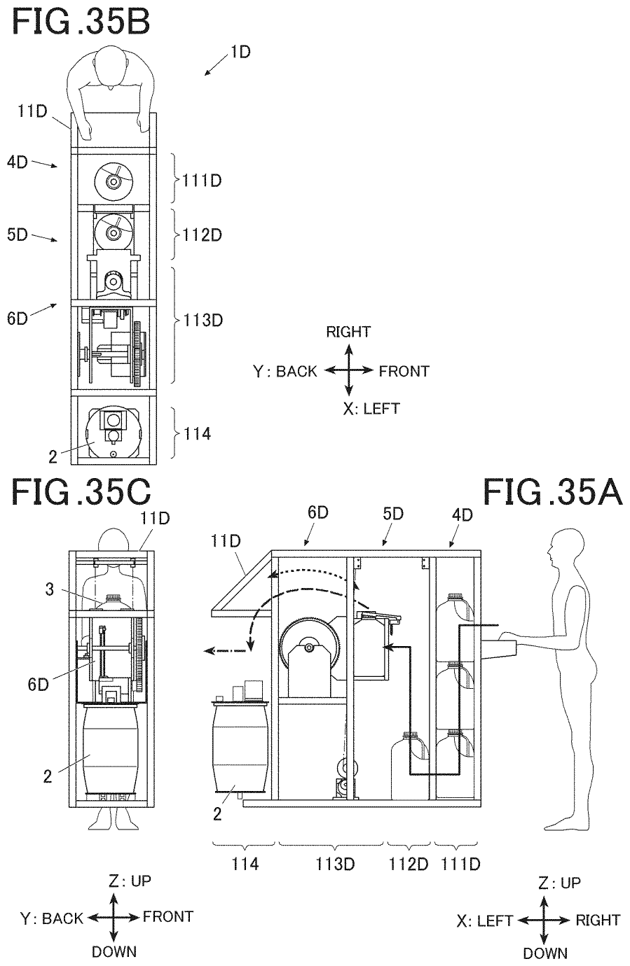

FIG. 34 is a perspective view of the ink supply apparatus 1D. FIG. 35A is a front view of the ink supply apparatus 1D, FIG. 35B is a left side view thereof, and FIG. 35C is a plan view thereof.

Regarding the ink supply apparatus 1D, the same reference numerals are denoted to the same components as those of the above-described ink supply apparatus 1, and repetitive description is omitted. The differences from the ink supply apparatus 1 will be mainly described.

The ink supply apparatus 1D is significantly different from the ink supply apparatus 1 in that the refill containers 3 are stored in a storage 4D in a position in which the longitudinal direction BL thereof is in the Z-axis direction. Hereinafter, the position in which the longitudinal direction BL of the refill container 3 is in the Z-axis direction is referred to as a “standing position”.

In the frame 11D, an installation area 111D for the storage 4D, an installation area 112D for a lift mechanism 5D, an installation area 113D for a conveyer 6D, and an installation area 114 for an ink tank 2 are arranged in order from right to left.

Since the refill containers 3 are stored in the storage 4D in the standing position, it is difficult to roll and move the refill container 3 to the lift mechanism 5D. To transfer the refill container 3 from the storage 4D to the lift mechanism 5D, for example, a linear actuator (not shown in the figure) pushes out the refill container 3.

Similar to the above-described lift mechanism 5, the lift mechanism 5D winds a chain to move up and down a lift plate 51D on which the refill container 3 is placed.

However, since the refill container 3 cannot be rolled, a linear actuator (not shown in the figure) pushes out the refill container 3 to pass the refill container 3 to the conveyer 6D at the receiving position.

The conveyer 6D has the same configuration as the conveyer 6. However at the receiving position, the conveyer 6D stands by in a position in which the longitudinal direction of the holding frame at the distal end of the arm is parallel to the Z-axis direction. When the refill container 3 is pushed from the lift mechanism 5D into the inlet/outlet of the holding frame, the refill container 3 is held by the bottle holding actuator.

Subsequent actions of the conveyer 6D are the same as those of the conveyer 6 of the ink supply apparatus 1.

The ink supply apparatus 1D has the same technical effect as the ink supply apparatus 1. Further, the refill container 3 is stored and conveyed in the standing position. This allows the narrower width of the frame 11D in the Y-axis direction, and it is possible to reduce the size of the apparatus.

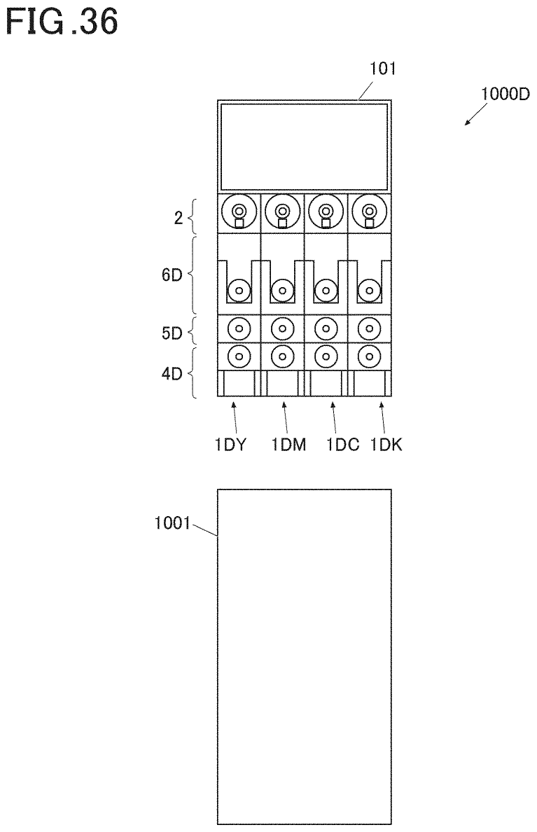

FIG. 36 is a plan view of an inkjet recording system 1000D composed of an ink supply system and the inkjet recording apparatus 1001, illustrating the configuration and layout thereof. The ink supply system includes ink supply apparatuses 1DY, 1DM, 1DC, and 1DK each of which has the same configuration as the ink supply apparatus 1D and which respectively supply YMCK inks.

Since each of the ink supply apparatus 1DY, 1DM, 1DC, and 1DK has a substantially rectangular shape in a plan view that is long in the X-axis direction, it is possible to save space by arranging the ink supply apparatus 1DY, 1DM, 1DC, and 1DK side by side in the short-side direction in the plan view. In this case, it is preferable to provide a waste bin 101 for discarding the empty refill container 3 at the end closer to the ink tank 2 of each ink supply apparatus 1DY, 1DM, 1DC, 1DK.

### [Others]

In the above embodiments, it is possible to reduce the workload for the replenishment and to replenish the liquid correctly.

While the present invention is described based on the above embodiments, suitable modifications can be made in the above embodiments without departing from the scope of the present invention.

For example, the ink supply apparatuses and ink supply systems are illustrated as examples of the liquid supply apparatus and liquid supply system. However, an object to be supplied is not limited to ink.

For example, when liquid is supplied to a liquid ejection apparatus that ejects metal paste, the liquid supply apparatus and liquid supply system can handle the metal paste as the liquid to be supplied.

When the liquid ejection apparatus is a 3D printer or the like, the liquid supply apparatus and liquid supply system can handle liquid material that solidifies in a predetermined condition, as the liquid to be supplied.

Although embodiments of the present invention have been described and illustrated in detail, the disclosed embodiments are made for purposes of illustration and example only and not limitation. The scope of the present invention should be interpreted by terms of the appended claims.

What is claimed is:

1. A liquid supply apparatus that supplies liquid to a liquid ejection apparatus, comprising:
a liquid tank that stores the liquid; and
a conveyer that loads a refill container to a refill position of the liquid tank to replenish the liquid.

2. The liquid supply apparatus according to claim 1, further comprising:
a storage that stores a plurality of the refill container,
wherein the conveyer conveys the refill container in the storage to the liquid tank.

3. The liquid supply apparatus according to claim 2, further comprising:
a controller that controls the conveyer to load the refill container in the storage to the refill position according to a liquid level of the liquid tank.

4. The liquid supply apparatus according to claim 1, wherein the conveyer loads the refill container in the refill position such that a discharge port of the refill container faces downward.

5. The liquid supply apparatus according to claim 1, further comprising: an opener that is disposed at the refill position and that opens the discharge port of the refill container.

6. The liquid supply apparatus according to claim 1, wherein the discharge port of the refill container is openable by a pressing force that acts when the conveyer loads the refill container to the refill position.

7. The liquid supply apparatus according to claim 1, wherein the conveyer performs a stirring action at a point in a conveyance path of the refill container.

8. The liquid supply apparatus according to claim 1,
wherein the liquid tank comprises a first liquid tank and a second liquid tank,
wherein the storage for storing the refill container comprises a first storage and a second storage, and
wherein the conveyer is composed of a single conveyer that performs a conveyance of the refill container in the first storage to a first refill position of the first liquid tank and a conveyance of the refill container in the second storage to a second refill position of the second liquid tank.

9. A liquid supply system, comprising: liquid supply apparatuses that are provided respectively for plural types of liquids, each of the liquid supply apparatuses being the liquid supply apparatus according to claim 1.
